(19) United States
(12) Patent Application Publication
(10) Pub. No.: US 2021/0027251 A1
(43) Pub. Date: Jan. 28, 2021

(54) COMPUTER SYSTEMS AND METHODS FOR SEARCHING MULTI-DIMENSIONAL CONTENT

(71) Applicant: Piazza Technologies, Inc., Palo Alto, CA (US)

(72) Inventors: Pooja Sankar, Palo Alto, CA (US); Brandon Fennell, Palo Alto, CA (US); Molly Johnson, Palo Alto, CA (US); Sunthar Premakumar, Palo Alto, CA (US); Craig Cockerill, Palo Alto, CA (US); Renars Gailis, Palo Alto, CA (US); Zach Wyzgoski, Palo Alto, CA (US); Sagar Gokhale, Palo Alto, CA (US)

(21) Appl. No.: 16/912,540

(22) Filed: Jun. 25, 2020

Related U.S. Application Data
(63) Continuation-in-part of application No. 14/749,455, filed on Jun. 24, 2015, now abandoned.
(60) Provisional application No. 62/019,879, filed on Jul. 1, 2014.
(60) Provisional application No. 62/019,874, filed on Jul. 1, 2014.
(60) Provisional application No. 62/130,439, filed on Mar. 9, 2015.

(51) Int. Cl. G06Q 10/10

(52) U.S. Cl. CPC G06Q 10/1053; G06Q 50/01

(57) ABSTRACT

The present disclosure provides computer systems and methods for searching for multi-dimensional career content over a network. The method comprises: collecting content related to educational attributes about a plurality of job candidates from one or more resources over the network; processing the content to identify a plurality of tags in the content and generating a contextual relationship among the plurality of tags; organizing the content in a memory location based on the plurality of tags and the contextual relationship that permits searching of the content along multiple dimensions; and providing, on a graphical user interface, a first panel comprising a plurality of filtering options corresponding to the multiple dimensions and a second panel displaying indicators for at least a subset of the plurality of job candidates, wherein the indicators are generated based on the contextual relationship and the plurality of tags.

### BACKGROUND OF THE INVENTION

With increasing complexity of the workforce today, there is an increasing demand for talent to meet various new and evolving positions. Talent management may generally refer to the anticipation of human capital for an organization and the planning to meet those needs. Talent management may use strategic human resource planning to improve business value and to make it possible for companies and organizations to reach their goals. Talent management may include recruiting, retaining, developing, rewarding, and strategic workforce planning. A talent-management strategy may need to link to business strategy. A talent-management system can enable companies to search for talent. Talent selection may offer a large return on investment. Job analysis and assessment validation may help enhance the predictive power of selection tools.

### SUMMARY OF THE INVENTION

Although there are approaches presently available to place individuals in workplaces, and there are approaches presently available to interact with individuals to apply to positions available in a workplace, recognized herein are various limitations with such approaches. For example, the search for talent and positions for that talent may be one-dimensional and may not take into account various variables that may impact the suitability of a given position for talent. This is problematic because a position that may best meet the abilities of a given individual may require the assessment of multiple factors (e.g. job status or work authorization) as opposed to a single factor (e.g., education). Additionally, the multiple factors may be sourced from a large array of sources that may not be readily available to companies that are seeking talent.

Another limitation is that campaigns that are used to reach out to prospective employees may not take into account whether the individual desires to be approached. This is problematic because talented individuals who may otherwise be interested in a position may disregard an opportunity that is presented in an unwanted manner. Accordingly, recognized herein is the need for better approaches of identifying talent, identifying positions for that talent, interacting with talent, and generating engagement campaigns for that talent. Through methods and systems described herein, engagement campaigns may be generated that are of genuine interested to potential talent. This, in turn, may increase the number of potential talent that pay attention to engagement campaigns from particular companies. In particular, the potential talent may trust that the companies generating the engagement campaigns are providing opportunities of interest to the potential talent.

The present disclosure provides computer systems (“systems”), including user interfaces, that provide a key set of tools to facilitate the discovery of technical talent, such as at the educational institution (e.g., university) level, and to facilitate the engagement of talent, such as via a talent engagement campaign or direct interaction (e.g. individual messaging). Computer systems of the present disclosure can include computer servers with computer processors, memory locations, user interfaces, and data storage units. Computer systems of the present disclosure can be employed for use in learning and talent discovery. Computer systems of the present disclosure can also be employed for use in developing, providing, and assessing engagement campaigns. Additionally, the computer systems can be used for storing data that can be employed for use in learning and talent discovery.

Systems of the present disclosure can provide platforms that include both a company-oriented platform and a student-oriented platform, each of which can aim to streamline the communication between industry and academia. The company platform can be centered on a new industry disruptive search feature that allows for the discovery of talent by leveraging data that may be gathered. Such data can be gathered by the system, such as using a learning platform of the system that can include various components, such as, for example, a question and answer (Q&A) component. The student platform can be centered on an exploratory interface that can allow students to discover the wide range of employment opportunities available to them. Systems provided herein can include a collaboration platform that enables homework submission, and provides details as to classes taken by a student, classes taught, assignments and class participation.

Systems of the present disclosure can include computer servers that can be a part of a learning hub or platform of users (e.g., students). The learning platform can include a Q&A component. The platform can enable users to collaborate. The learning hub can facilitate learning at the educational institution level (e.g., colleges). Users can collaborate over various matters, including coursework. Other uses, such as companies, can use the platform to actively target and recruit other users (e.g., college users) where they are already engaged.

Systems of the present disclosure can be employed for use with learning, talent discovery and relationship management. Systems provided herein can be used to build relationships among students.

Additionally, systems of the present disclosure can also provide campaign engagement platforms that provide the ability for generating, sending, and assessing engagement campaigns so as to streamline the communication between industry and academia. The campaign platforms can be directed towards a new industry disruptive, contextualized search feature that allows for the discovery of talent by leveraging gathered data. Additionally, the gathered data may be contextualized based on how approachable candidates are to a given campaign. Such contextual data may include campaign preferences that are gathered based on user input and/or historical recipient interactions with previous campaigns. For example, campaign preferences may be based on data from past interactions of a recipient with a company. These past interactions may include previous campaigns, messages, or whether the recipient has engaged with the company. These past interactions may be used to decide whether the recipient will receive a particular campaign. As such, the campaign platform may be centered towards engaging recipients, such as students, with campaigns that provide opportunities such as a wide range of employment opportunities (e.g. awareness for upcoming events, invitations to events, and/or branding and awareness for general or specific employment opportunities).

In an aspect, the present disclosure provides a computer system for learning and/or talent discovery. The computer system comprises an electronic display comprising a user interface that includes a search field and a facet field for refining a search directed to a query inputted in said search field. Said query is directed to learning or talent discovery. Additionally, said facet field displays one or more descriptors that are indicative of a characteristic of one or more users or courses that are returned from a search directed to said query. Further, said facet field displays a number of users or courses associated with each of said one or more descriptors. The computer system also comprises a computer processor coupled to said electronic display. Said computer processor is programmed to (i) receive said query from said user through said search field, (ii) conduct a search of users and/or courses directed to said search query, and (iii) present one or more results of a search directed to said query in said user interface. Additionally, said one or more results include users and/or courses meeting said query. Further, said one or more results include said one or more descriptors in said facet field of said user interface.

In another aspect, the present disclosure provides a method for searching for content directed to learning and/or talent discovery. The method comprises receiving a request for a search for a user, said request comprising a query directed to learning or talent discovery. Additionally, the method comprises conducting, with a programmed computer processor, a search of users directed to the search query. The method further comprises providing a result of the search directed the query, wherein the result includes one or more descriptors in a facet field, wherein the facet field is (i) indicative of a characteristic of one or more users or courses that are returned from a search directed to said query and (ii) includes a number of users or courses associated with each of the one or more descriptors.

In an additional aspect, the present disclosure provides a method for storing content directed to learning and/or talent discovery. The method comprises using a computer processor, analyzing content in a memory location to identify one or more tags in said content, wherein said content is directed to learning and/or talent discovery. The method also comprises generating at least one contextual string comprising said one or more tags, which contextual string is indicative of a contextual relationship among said one or more tags that would otherwise not be available from said one or more tags alone. Additionally, the method comprises storing said contextual string in an electronic data repository coupled to said computer processor. The method also comprises providing said contextual string for use in conducting a search around a query directed to learning or talent discovery.

In another aspect, the present disclosure provides a method for searching for content directed to learning and/or talent discovery. The method comprises receiving a request for a search from a user, which request comprises a query directed to learning or talent discovery. Additionally, the method comprises using said computer processor, conducting a search of an electronic data repository comprising contextual strings for a match between said query and at least one contextual string in said electronic data repository, which contextual string is indicative of a contextual relationship among tags in said contextual string that would otherwise not be available from said tags alone. The method also comprises, upon said search, identifying one or more results that comprise content that at least partially matches said query, wherein said content is directed to learning or talent discovery, and wherein said content comprises at least a subset of said tags. The method also comprises making said one or more results accessible to said user.

In an additional aspect, the present disclosure provides a computer system for storing content. The computer system provides an electronic data repository for storing contextual strings that are indicative of a contextual relationship among tags. Additionally, the computer system comprises a computer processor coupled to said electronic data repository. In particular, said computer processor is programmed to analyze content directed to learning and/or talent discovery in a memory location to (i) identify tags in said content, (ii) generate at least one contextual string comprising said tags, which contextual string is indicative of a contextual relationship among said tags that would otherwise not be available from said tags alone, (iii) store said contextual string in said electronic data repository, and (iv) provide said contextual string for use in conducting a search around a query directed to learning or talent discovery.

In another aspect, the present disclosure provides a computer system for storing content. The computer system comprises an electronic data repository for storing contextual strings that are indicative of a contextual relationship among tags. Additionally, the computer system comprises a computer processor coupled to said electronic data repository. In particular, said computer processor is programmed to (i) receive a request for a search from a user, which request comprises a query, (ii) conduct a search of said electronic data repository for a match between said query and at least one contextual string in said electronic data repository, which contextual string is indicative of a contextual relationship among tags in said contextual string that would otherwise not be available from said tags alone, (iii) identify one or more results that comprise content that is identified to match said query, wherein said content is directed to learning and/or talent discovery, and wherein said content comprises at least a subset of said tags, and (iv) make said one or more results accessible to said user.

The present disclosure also provides, in an aspect, a computer system for talent campaign management. The computer system comprises an electronic display comprising a user interface that includes a first panel listing at least a subset of students among a plurality of students who have each responded to a targeted message among targeted messages as part of a talent campaign, a second panel showing a reply message from a select one of said one or more students in response to said targeted messages being directed to said plurality of students, and a third panel with metrics of said talent campaign, which metrics include one or more of (i) a number of targeted messages sent to students as part of said talent campaign, (ii) a number of students who have read said targeted messages, (iii) a number of students who replied to said targeted messages, (iv) a number of students who have taken an action within said targeted messages, and (v) a number of students who have viewed a profile associated with said talent campaign. Additionally, the computer system comprises a computer processor coupled to said electronic display, wherein said computer processor is programmed to (i) receive responses from said at least said subset of students among said plurality of students in response to said targeted messages being directed to said plurality of students as part of said talent campaign, (ii) update said first panel to reflect said subset of students, (iii) display said reply message in said second panel upon user input in said first panel, and (iv) update said metrics in said third panel.

Another aspect of the present disclosure provides a method for providing a talent campaign to a targeted audience. The method comprises identifying a talent campaign audience of potential talent. The method also comprises determining a subset of potential talent among said audience based on one or more campaign preferences of the talent campaign audience. Additionally, the method comprises organizing message content into a campaign template on a user interface to provide a campaign message, which message content is directed to said talent campaign. The method also comprises providing with a computer processor said campaign message to said subset of potential talent.

In an additional aspect, the present disclosure provides a computer system for providing a talent campaign. The computer system comprises an electronic display comprising a user interface that includes a search field for accepting a query directed to identifying recipients of said talent campaign. Additionally, the computer system comprises a computer processor coupled to said electronic display, wherein said computer processor is programmed to (i) receive said query through said search field, (ii) conduct a search of recipients directed to said query, (iii) present results of said search directed to said query in said user interface, wherein said results include recipients each having one or more descriptors meeting said query, and (iv) directing a targeted message to said recipients as part of said talent campaign.

In another aspect, the present disclosure provides a computer system for learning and/or talent discovery. The computer system can comprise an electronic display comprising a user interface that includes a search field and a facet field for refining a search directed to a query inputted in the search field. The query can be directed to learning or talent discovery and contain both keywords and descriptors. The facet field can display one or more descriptors that are indicative of a characteristic of one or more users or courses that are returned from a search directed to the query. In some cases, the facet field can display a number of descriptors associated with a subset of the users (e.g. students) returned based on the initial query. The facet field can display a number of different specific descriptors (e.g., courses, majors, graduation year, etc.) based on selection. The computer system can further comprise a computer processor coupled to the electronic display. The computer processor can be programmed to (i) receive the query from the user through the search field, (ii) conduct a search of users and/or courses directed to the search query, and (iii) present one or more results of a search directed to the query in the user interface. The one or more results can include users and/or courses meeting the query. The one or more results can be based on one or more descriptors in the facet field or a combination of keywords and descriptors in the main search field of the user interface.

In an embodiment, the computer processor is also programmed to receive a selection of a given descriptor among the one or more descriptors and update the one or more results on the user interface without conducting another search. This is conducted using the facets field. In another embodiment, the one or more results include an indication as to the number of users that are following a given course among the one or more courses. In another embodiment, the users are students and/or companies.

Another aspect of the present disclosure provides a method for storing content directed to learning and/or talent discovery, comprising of using a computer processor, analyzing content in a memory location to identify tags in the content. The content can be directed to learning and/or talent discovery. Tags store the information searched for when using various descriptors. The relationship of these tags is stored with an artificial sentence(s) relating these items (e.g. a contextual string). The contextual string can be indicative of a contextual relationship among the tags that would otherwise not be available from the tags alone. The contextual string can then be stored in an electronic data repository coupled to the computer processor. In some cases, the one or more tags are stored in an electronic data repository coupled to the computer processor.

Another aspect of the present disclosure provides a method for searching for content directed to learning and/or talent discovery, comprising receiving a request for a search from a user, which request comprises a query. Next, using the computer processor, a search of an electronic data repository comprising contextual strings can be conducted for a match between the query and at least one contextual string in the electronic data repository. The contextual string can be indicative of a contextual relationship among tags in the contextual string that would otherwise not be available from the tags alone. Upon the search, one or more results can be identified that comprise content that at least partially matches the query. The content can be directed to learning and/or talent discovery. The content can comprise at least a subset of the tags. Next, the one or more results are made accessible to the user. In some situations, the query can comprise at least one or a plurality of tags. The one or more results can be presented on a user interface of an electronic device of the user.

Another aspect of the present disclosure provides a computer readable medium comprising machine executable code that, upon execution by one or more computer processors, implements any of the methods above or elsewhere herein.

Another aspect of the present disclosure provides a computer system comprising one or more computer processors and a memory location that comprises machine executable code that, upon execution by the one or more computer processors, implements any of the methods above or elsewhere herein.

Another aspect of the present disclosure provides a computer system comprising an electronic data repository for storing contextual strings that are indicative of a contextual relationship among tags and a computer processor coupled to the electronic data repository. The computer processor can be programmed to analyze content in a memory location to (i) identify tags in the content, (ii) generate at least one contextual string comprising the tags, which contextual string is indicative of a contextual relationship among the tags that would otherwise not be available from the tags alone, and (iii) store the contextual string in the electronic data repository.

Another aspect of the present disclosure provides a computer system for storing content, comprising an electronic data repository for storing contextual strings that are indicative of a contextual relationship among tags, and a computer processor coupled to the electronic data repository. The computer processor can be programmed to (i) receive a request for a search from a user, which request comprises a query, (ii) conduct a search of the electronic data repository for a match between the query and at least one contextual string in the electronic data repository, which contextual string is indicative of a contextual relationship among tags in the contextual string that would otherwise not be available from the tags alone, (iii) identify one or more results that comprise content that is identified to match the query, wherein the content is directed to learning and/or talent discovery, and wherein the content comprises at least a subset of the tags, and (iv) make the one or more results accessible to the user.

An aspect of the present disclosure provides a method for storing content directed to developing engagement campaigns, comprising using a computer processor and analyzing content in a memory location that is associated with recipients who may be targeted with engagement campaigns. Such content analysis may include identifying tags in the content. The content can be directed to identify a campaign audience, campaign preferences, and/or historical campaign interactions. Further, examples of campaign preferences may include messaging preferences (e.g., opt-in or opt-out preferences), date preferences (e.g., prefer to be contacted on a Tuesday or Wednesday), and industry preferences (e.g., prefers to be contacted by companies in the health care industry).

Next, campaign preferences of a recipient may be stored in a way that allows recipients having shared campaign preferences to be grouped together. In some examples, at least one contextual string comprising the tags is generated. The contextual string can be indicative of a contextual relationship among the tags that would otherwise not be available from the tags alone. The contextual string can then be stored in an electronic data repository coupled to the computer processor. In some cases, the one or more tags are stored in an electronic data repository coupled to the computer processor.

Another aspect of the present disclosure provides a method for searching for content directed to generating engagement campaigns, comprising receiving a request for a search from a campaign organizer. The request comprises a query. Next, using the computer processor, a search of an electronic data repository can be conducted for a match between the query and data stored within the electronic data repository. For example, the electronic data repository may include contextual strings and the search may be conducted to find a match between the query and at least one contextual string in the electronic data repository. The contextual string can be indicative of a contextual relationship among tags in the contextual string that would otherwise not be available from the tags alone. Upon the search, one or more results can be identified that comprise content that at least partially matches the query. The content can be directed to identifying a campaign audience. In some situations, the query can comprise at least one or a plurality of tags. The content can also include information regarding a recipient's campaign preferences (e.g., opting-out of campaigns, or opting-in to only certain types of campaigns). In some examples, the content can comprise at least a subset of the tags. Next, the one or more results are made accessible to the campaign organizer. A campaign organizer may be a company that is attempting to engage with talent. The one or more results can be presented on a user interface of an electronic device of the campaign organizer.

Another aspect of the present disclosure provides a computer readable medium comprising machine executable code that, upon execution by one or more computer processors, implements any of the methods above or elsewhere herein.

Another aspect of the present disclosure provides a computer system comprising one or more computer processors and a memory location that comprises machine executable code that, upon execution by the one or more computer processors, implements any of the methods above or elsewhere herein.

Another aspect of the present disclosure provides a computer system comprising an electronic data repository for storing contextual strings that are indicative of a contextual relationship among tags and a computer processor coupled to the electronic data repository. The computer processor can be programmed to analyze content in a memory location to (i) identify tags in the content, (ii) generate at least one contextual string comprising the tags, which contextual string is indicative of a contextual relationship among the tags that would otherwise not be available from the tags alone, and (iii) store the contextual string in the electronic data repository.

Another aspect of the present disclosure provides a computer system for storing content, comprising an electronic data repository for storing contextual strings that are indicative of a contextual relationship among tags, and a computer processor coupled to the electronic data repository. The computer processor can be programmed to (i) receive a request for a search from a campaign organizer, which request comprises a query, (ii) conduct a search of the electronic data repository for a match between the query and at least one contextual string in the electronic data repository, which contextual string is indicative of a contextual relationship among tags in the contextual string that would otherwise not be available from the tags alone, (iii) identify one or more results that comprise content that is identified to match the query, wherein the content is directed to identifying a campaign audience of recipients and/or information related to campaign preferences of the one or more recipients, and wherein the content comprises at least a subset of the tags, and (iv) make the one or more results accessible to the campaign organizer.

Another aspect of the present disclosure provides a computer system for campaign management. The computer system may comprise an electronic display comprising a user interface that includes a first panel listing at least a subset of students among a plurality of students who have each responded to a targeted message among targeted messages as part of a talent campaign, a second panel showing a reply message from a select one of said one or more students in response to said targeted messages being directed to said plurality of students, and a third panel with metrics of said talent campaign, which metrics include one or more of (i) a number of targeted messages sent to students as part of said talent campaign, (ii) a number of students who have read said targeted messages, (iii) a number of students who replied to said targeted messages, (iv) a number of students who have taken an action within the message, and (v) a number of students who have viewed a profile associated said talent campaign. The computer system may also comprise a computer processor coupled to said electronic display, wherein said computer processor is programmed to (i) receive responses from said at least said subset of students among said plurality of students in response to said targeted messages being directed to said plurality of students as part of said talent campaign, (ii) update said first panel to reflect said subset of students, (iii) display said reply message in said second panel upon user input in said first panel, and (iv) update said metrics in said third panel.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a user interface comprising a search field;

FIG. 2 is a screenshot of a user interface with an example home page;

FIG. 3 is a screenshot of a user interface with a search field;

FIG. 4 is a screenshot of a user interface with a search field and filters;

FIG. 5 is a screenshot of a user interface showing the results of a search;

FIG. 6 is a screenshot of a user interface showing student streams with a student search field and various search options;

FIG. 7 is a screenshot of a user interface showing a layout of a user in a search stream;

FIG. 8 is a screenshot of a user interface showing an events dashboard;

FIG. 9 is a screenshot of a user interface showing a messaging interface;

FIG. 10 is a screenshot of a user interface showing a profile analytics dashboard;

FIG. 11 is a screenshot of a user interface showing activity analytics;

FIG. 12 is a screenshot of a user interface with an example company profile;

FIG. 13 is a screenshot of a user interface with an example entry from a people section of a company profile;

FIG. 14 is a screenshot of a user interface with a gateway to a careers component;

FIG. 15 is a screenshot of a user interface with an example companies dashboard;

FIG. 16 is a screenshot of a user interface with an example student profile;

FIG. 17 is a screenshot of a user interface with an example interface component of a resume tagging tool;

FIG. 18 schematically illustrates a method for storing content;

FIG. 19 schematically illustrates a method for searching content;

FIG. 20 schematically illustrates a workflow for storing user profiles;

FIG. 21 shows a user interface illustrating searching options associated with a process of selecting an audience for a campaign, in accordance with embodiments of the present invention;

FIG. 22 shows a user interface illustrating messaging options, in accordance with embodiments of the present invention;

FIG. 23 shows a user interface illustrating input options associated with a process of generating campaign content, in accordance with embodiments of the present invention;

FIG. 24 shows a user interface illustrating preview options for reviewing an engagement campaign notification, in accordance with embodiments of the present invention;

FIG. 25 shows a user interface illustrating a campaign administration page, in accordance with embodiments of the present invention; and

FIG. 26 schematically illustrates a computer system that is programmed or otherwise configured to implement methods and user interfaces of the present disclosure.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “user,” as used herein, generally refers to an individual or entity that uses systems and methods of the present disclosure. In some examples, a user is a student, teacher, recruiter (or other company employees), or a company.

The term “répondez s'il vous plaît” (or RSVP), as used herein, generally refers to a request for a response from an invited person or people, or an indication of a willingness to attend an event.

The term “content,” as used herein, generally refers to an item that includes graphical, textual, audio and/or video information. Data can include content. Content can be provided from various sources, such as by a user (e.g., student, school or company) and/or automatically aggregated by a computer system of the present disclosure, such as from one or more social network sources (e.g., Facebook® and Twitter®).

The term “follow,” as used herein, generally refers to a user's express interest in another user. For example, a student can express interest in a school or company by following a company.

### User Interfaces for Facilitating Learning and Talent Discovery

An aspect of the present disclosure provides computer systems with user interfaces that facilitate learning and/or talent discovery. A user interface can be a graphical user interface (GUI) or a web-based user interface. The user interface can be displayed on an electronic display of an electronic device of a user, such as a mobile (or portable) electronic device.

In some embodiments, a user interface for facilitating learning and/or talent discovery includes a search field. The search field can be a search box or search panel. The search field can enable a user to input search criteria, such as textual and/or graphical information that is directed to search for one or more classes and/or users. The search field can be configured to accept textual information for natural language searching.

The user interface can include one or more output fields that can each display an output of the search. The user interface can include at least 1, 2, 3, 4, 5, 6, 7, 8, 9, 10, 20, 30, 40, 50, 60, 70, 80, 90 or >=100 output fields. In some situations, the user interface can include a comprehensive set of tools to allow users (e.g., students or companies) to augment their experience.

A computer system (“system”) for learning and/or talent discovery can comprise an electronic display that has a user interface that includes a search field and at least one facet field for refining a search. The search can be directed to a query inputted in the search field. The query can be directed to talent discovery. The facet field can display one or more descriptors that are indicative of a characteristic of users (e.g., majors, courses in a given taxonomy (e.g. Computer Science, or more specifically Machine Learning), skills, or any other descriptor) that are returned from a search directed to the query. The one or more descriptors can be descriptors that map to specific data associated with a user's profile. The descriptors can be graphical, textual and/or audio descriptors. The facet field can display the number of users associated with each of the one or more descriptors, such as by way of histograms and/or numerical descriptors. The computer system further comprises a computer processor coupled to the electronic display. The computer processor can be programmed to (i) receive the query from the user through the search field, (ii) conduct a search of users directed to the search query, and (iii) present a result of a search directed to the query, which result includes the one or more descriptors in a facet field which can be used to further refine search.

The system can be used by students and organizations, such as companies. The system can have features and functionalities that are dedicated for use by select users. In some examples, a student-side of the system has features and functionalities that are accessible by students only, and a company-side of the system has features and functionalities that are only accessible by companies.

In some cases, a user can access any of the one or more descriptors to refine the search results as a preview on the user interface. In some situations, for the preview the search results may not be recalculated. The selected descriptor can be presented on the user interface. Upon selecting a facet, the computer processor can process a query with the additional filters added per the selected facet. This can enable the user to pivot about a given facet.

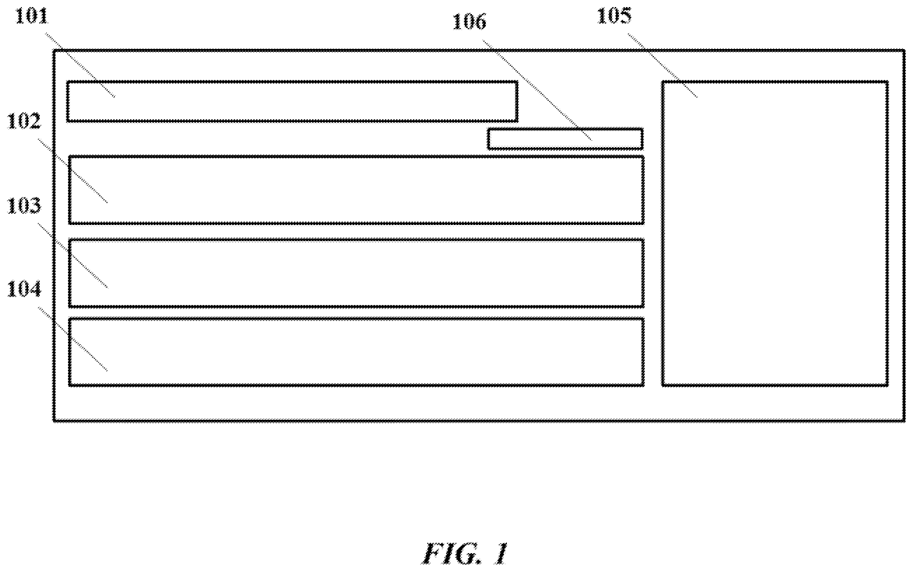

FIG. 1 shows a user interface comprising a search field 101 and results 102, 103, and 104. The results 102-104 can include information that may be relevant to a query inputted in the search field 101. The user interface further includes a facet field 105 that displays one or more descriptors that are indicative of a characteristic of users that are returned from a search directed to the query inputted in the search field 101. A user can perform a first type of selection (e.g., click) on the user interface to apply a given descriptor to the search, in which case the search can be conducted with the descriptor added as a filter, or perform a second type of selection (e.g., double click) on the user interface to pivot about the descriptor and recalculate the number of users shown for each of the descriptors in the facet fields with this additional constraint applied to the global search. Upon refining a search, additional filters can be displayed in a filter field 106.

The ability to refine search results without conducting an additional search may provide various benefits. For instance, the ability to refine search results without conducting an additional search is more efficient. Additionally, refining of search results may be conducted even if a user is not within an area that has cell reception. The ability to refine search results without conducting a second search may also save a user resources (e.g., money) when a user is accessing the system from a mobile device that has a data-based pricing plan for the mobile device.

A user interface can include graphical, textual, audio and/or video elements. User interfaces can include icons, panels and interactive fields that enable a user to interact with systems provided herein. User interface elements can be arranged in a manner that meets various features and functionalities of systems of the present disclosure. Such arrangement can be generated by a computer processor, such as, for example, upon execution of machine-executable code that conducts a search and generates an output. User interface elements can be static (i.e., not changing) or dynamic (i.e., changing). Dynamic elements can be updated, for example, based on a search. For instance, a user interface can be updated to display search results.

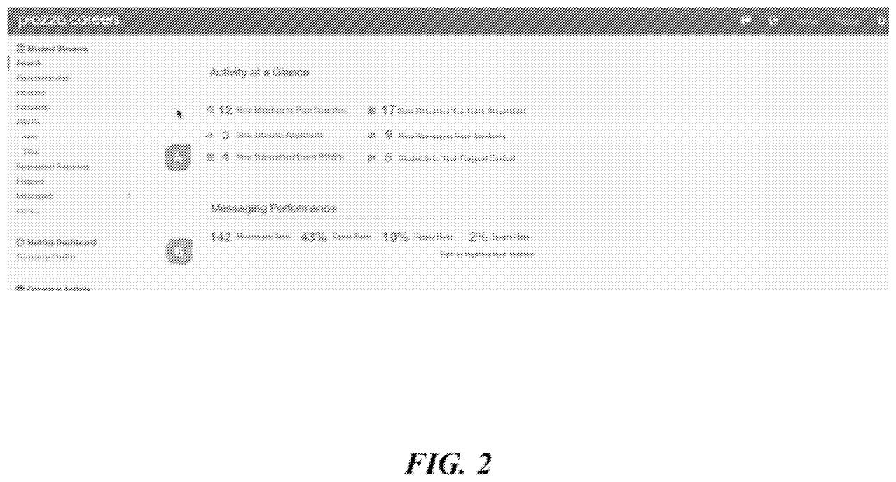

The present disclosure provides user interfaces for enabling users to search for talent. A user interface can include a home page that gives an overview of a user's current status of activities. An example home page is shown in FIG. 2. The homepage content can be distributed into a list of new activity on the platform (FIG. 2, A) and messaging performance metrics (FIG. 2, B).

The homepage can include an “activity at a glance” section. The “activity at a glance” section displays a number of values (e.g., six values) for metrics to report the current actionable items on the system to the user. These actionable items can include, without limitation, new matches to past searches, new inbound applicants, new subscribed event reservations (RSVPs), new resumes that have been requested by the user, new messages from other users (e.g., students), and students in a flagged bucket. The new values can be graphically indicated, such as in a first color (e.g., blue). If no new items are present for a specific metric, the value may be presented in a second color (e.g., grey) and reflect the total number of items that have occurred for the metric. For example, if a user has no inbound applicants, the value can reflect total inbound applicants in grey instead of new inbound applicants in blue. In an example, the value for students in a flagged bucket can display the total number in grey.

The user interface can display messaging performance that can be represented through a series of funneled metrics. The product reports the total number of messages sent by a given user. From this, the open rate, reply rate, and spam rate can be calculated. These values can be determined by using electronic notifications (e.g., email) that may require the user to login to the product in order to view and take action on the message. The number of students who flag a company message as spam can determine spam rates. On the user interface, the metrics can change color (e.g., red/green) to provide additional visual feedback, based on an individual user's performance and predefined performance thresholds.

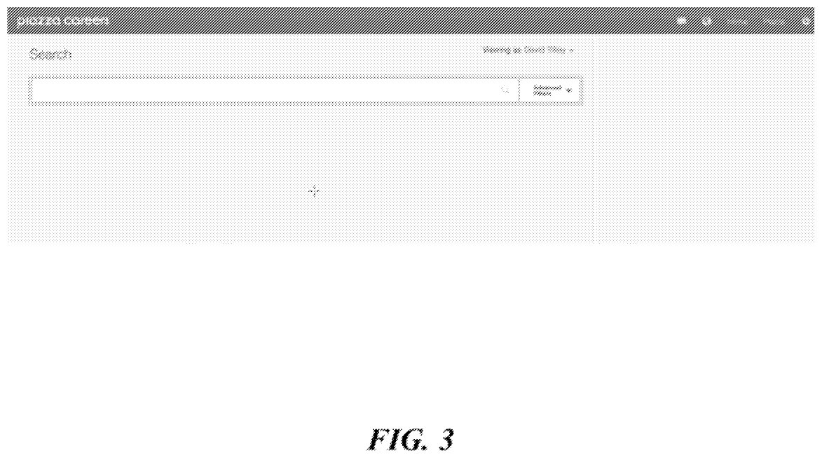

The user interface can include a search feature that allows users (e.g. recruiters or other personnel employed by a company) to find other users (e.g., students) using search criteria that can include one or more keywords, such as a combination of keywords, filters, and descriptors (FIG. 3). The search bar can seed initial suggestions using an autocomplete dropdown menu. In FIG. 3, the user interface includes a search field in which a user can input search criteria, which can include one or more keywords, filters, or descriptors.

The system provides the user with the ability to see their most recent searches (e.g., 50 stored for each user) below the search bar (not shown). The user will also be able to view recent searches run by any other users associated with a given company. The user will have the ability to save these searches. If the user is a student, the user will be able to add or change information on a profile of the user that creates a match to the search query. The user can be notified on the same page of the user interface.

User interfaces of the present disclosure can enable a user to provide various search criteria, which can be used by the system to conduct a search. Such search criteria can include one or more keywords. Keyword searches can search the entire user (e.g., student) profile, including, but not limited to, any resumes that may have been uploaded to the system. The search can support Boolean operators and quotes. In some examples, the search feature can be supported using a search engine (e.g., Sphynx).

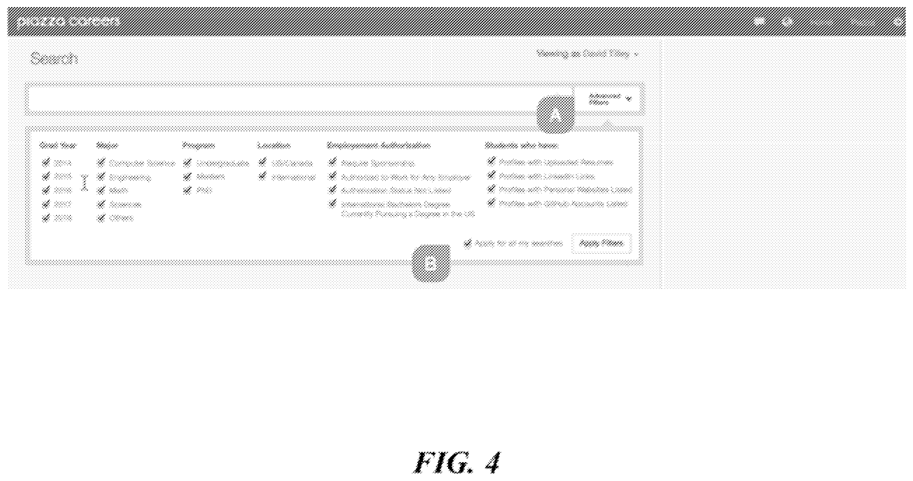

Along with keywords, a search can be conducted and further refined using filters. Filter can be performed by a number of additional parameters (see FIG. 4). These can be set prior to the search (FIG. 4, A) and can be applied as defaults for future searches (FIG. 4, B). In the student context, specific filters can include academic credentials (e.g., graduation year, major, program of study, and location of study), employment authorization, and specific student profile attributes (e.g., uploaded resume, specific web links, and anything else associated with the student profile or student preferences).

User interfaces of the present disclosure can present descriptors, which can map to specific data associated with a profile of a user (e.g., student). In the context of school, this can include student academic credentials. Student academic credentials may include an identification of a school name (e.g. Stanford University) and program (e.g. PhD, Masters, Undergraduate degree). Additional examples may include the classes the user may have taken, where they have worked, their name, their year and month of graduation, their name, and other skills and accomplishments from their resumes. Additional descriptors can cover any information known about or reported by a given user (e.g. employment status, job preferences, etc.). Classes that the user may have taken may include classes that were taken in an online format; classes where the user was a top student; classes where the user was recommended by a professor; when the class was taken, etc. In examples, classes where the user was a top student may be determined based on an algorithm. Additionally, descriptors may be based on classes where user acted as a TA (teaching assistant), the professor of the class, and what academic period/year the user was a TA. Further user profile information that may be used for descriptors includes, but is not limited to, information related to personal projects; previous employments; roles in which the users is interested; specific skills (e.g. Ruby coding, Python coding); associated skill level of specific skills (e.g., beginner, intermediate, advanced); and social media links such as Twitter, Github, LinkedIn, and Stack Overflow.

In further examples, descriptors may map to additional information such as current job status (e.g. seeking an internship, seeking a full time job, accepted an internship, accepted a full time job) as well as employment authorization (e.g. can work in a particular country, such as the U.S., or needs work authorization). These descriptors can allow for more specific search dimensions. Additionally, descriptors may allow grouping on specific parameters, including but not limited to geography. For example, schools within a particular geographic may be searched. These geographic groupings may be by State, Region, or Country, in examples. In other examples, group majors may be compiled (e.g., all computer science majors from the University of California at Berkeley). In further examples, each school in a particular state, such as California, may be searched. Certain descriptors can also support taxonomic organization (e.g., for courses, majors and indicators) to allow for more targeted searches unsupported by traditional keyword search queries. Descriptors can support keyword search within their respective datasets.

The present disclosure provides various descriptors. In some examples, a “worked at” descriptor can search for students who have worked at specific companies. The descriptor supports autosuggestion. If looking for a student who has worked at a given company, the following query can return the desired or predetermined result: worked_at=(“Company”). A student name descriptor can allow for searches within the student name field. A school descriptor can allow for searches for specific schools. It also supports searches within custom defined school lists. In some examples, by default two set lists can be “Top CS Schools” and “Long Tail Schools.” User interfaces of the present disclosure can support such technical or advanced query language.

A class descriptor can allow for searches for specific courses based on taxonomy, difficulty, role, and performance. Taxonomies and course levels can represent a mapping of all data in our system into higher-level taxonomies, to allow for more robust and easier searching. The breadth of available categories is set forth below.

A computer science (CS) taxonomy can include, without limitation: Algorithms/Data Structures, Artificial Intelligence, Compilers, Computational Science, Computer Gaming, Computer Graphics, Computer Networks, Computer Security, Computer Vision, Data Mining, Data Science, Databases, Distributed Systems, Human Computer Interaction, Information Retrieval, Machine Learning, Mobile Development, Natural Language Processing, Operating Systems, Other, Parallel Computing, Programming, Robotics, Theory of Computing, User Interfaces, Web Development. A science, technology, engineering, and math (STEM) taxonomy can include, without limitation: Computer Science (higher level taxonomy for CS, all CS taxonomies are included), Chemistry, Mathematics, Statistics/Probability, Biology, Electrical/Computer Engineering, Physics, Astronomy/Astrophysics, Biochemistry, Other Engineering, Aerospace/Mechanical Engineering, Biomedical Engineering, Bioengineering, Robotics, Bioinformatics, Chemical Engineering, Civil/Environmental Engineering.

User interfaces and systems of the present disclosure can provide users with various options. Such options can be employed in various settings, such as the school setting. A filter on the classes descriptor combines specific criteria to create more focused search results. For example, if a user is searching for students who have taught graduate level web development classes, the following query can return the desired result: _classes=(“Web Development”|“TAs”|“grad classes”). Such criteria, as with other components (e.g. filters, keywords, and other descriptors), of search, can include “AND”, “OR”, and “NOT” queries via symbols. These filters can include without limitation filtering by course level (e.g. lower division, upper division, or graduate level), participating in the class (e.g. top student), role in the class (e.g. as a teaching assistant), term of the course (e.g. Spring 2015, etc.), or professor.

A major descriptor can allow for searches for specific majors. Since many schools can have unique names for the same type of major, higher-level taxonomies are also available to allow for more robust and easier searching. As with the other descriptors, keyword search and Boolean logic is also supported. Major Taxonomies can include one or more of the following: Aerospace Engineering, Bioengineering, Biology, Business, Chemical Engineering, Chemistry, Civil Engineering, Cognitive Science, Computational Engineering, Computer Engineering, Computer Science, Design, Economics, Electrical Engineering, Environmental Engineering, Finance, General Engineering, Humanities/Social Science, Industrial Engineering, Information Science, Information Technology, Law, Mathematics, Mechanical Engineering, Operations Research, Physics, Psychology, Statistics, Structural Engineering.

When a user uploads a resume, a set of context driven data can be extracted from the resume. For example, a candidate may provide information that the candidate is a Masters student at Stanford University graduating in 2014 and majoring in Chemistry. The context driven data can include specific descriptors (e.g., indicators) that can be important parameters useful in making employment decisions, but which may not be easily found using keyword searches. For example, context driven data may associate the information that candidate is at Stanford University with the information that candidate is studying Chemistry. Some of this data can also be interpolated or extracted from information provided by students on their profiles. For example, if candidate information is provided that the candidate was “a TA for Chem 33: Introduction to Organic Chemistry, a chemistry class, for Prof. Brown in Spring 2013,” it may be determined that the candidate not only worked with Prof. Brown, but that the candidate worked for Prof. Brown.

Additional information can also be associated with information based on context. For example, associated information may be used to indicate that candidate is not only a Masters Student in Chemistry at Stanford, but also that Stanford is a very highly ranked educational institution. In another example, information that candidate is proficient in Python and is an expert in Microsoft Powerpoint may be used to recognize that the candidate has broad cross-platform skills. This deduction would not be possible based on the two pieces of information (proficiency in Python, expert in Microsoft Powerpoint) that would not be able to be inferred based on each individual piece of information alone.

Examples of additional resume-based indicators can include, without limitation, the following: has side projects; has started a company; has full time work experience; has industry internship experience; has been coding since high school; has participated in sports during college; held a leadership position in a student group; has mobile experience outside of the classroom (e.g., Android, iOS, published an app); has participated in technical competitions (e.g., was a finalist, participated in a hackathon/coding competition, was a finalist in a hackathon/coding competition, participated in a robotics competition, or was a finalist in a robotics competition); has participated in non-technical competitions (e.g., was a finalist); is affiliated with an student group (e.g., a music-related group, a robotics group, an entrepreneurship group, a consulting/debate group, a volunteer group, an honors society, a hacking/coding group, a women's group, a minority group, or an LGBT group); has won an award (e.g., received a scholarship); and is affiliated with diversity (e.g. gender, ethnicity, etc.).

Along with the other descriptors (including the resume-based indicators), several other basic descriptors may be employed to support a facet search, including the year descriptor which can define year of graduation; the program descriptor which can define a type of program (e.g., undergraduate, masters, doctoral); and the resume descriptor which can define or indicate whether a student has a resume or not; the work_auth descriptor, which can define or indicate whether the student has the ability to work in a given jurisdiction (e.g., the United States); a link descriptor which can define or indicate whether the student has a network account (e.g, Github, Stackoverflow, Linkedin, Twitter or Personal Links); and a skills descriptor which can define or indicate specific skills possessed by a student with support for levels.

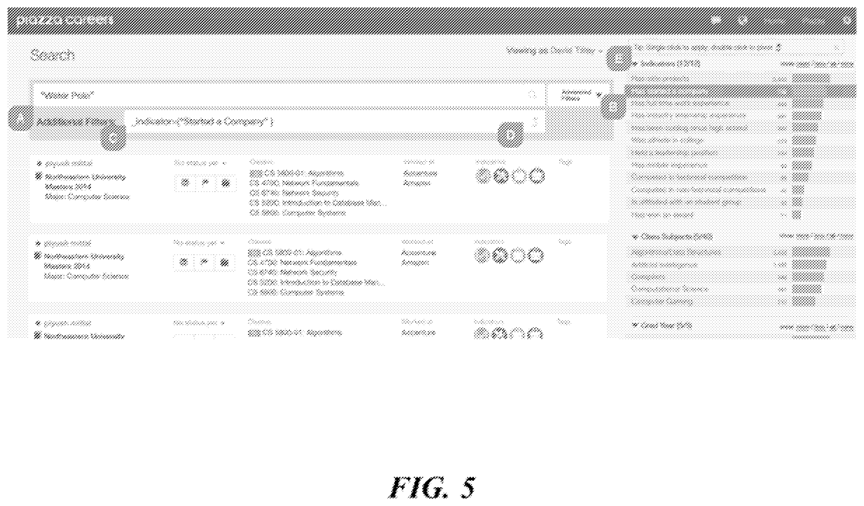

A descriptor can be a facet in a search. Along with being able to use a given descriptor in an explicit search query, the descriptor can be used in the search refinement process, as shown in FIG. 5. The system can be programmed to enable the facet search. The user interface of the system can be configured and adapted to provide search results based on the facet search.

With reference to FIG. 5, each search can starts with a global query (FIG. 5, A) such as “water polo.” Once the query has been submitted, a list of facets for further refining the search can appear on a right panel of the user interface. The number of students in this panel can be visually depicted with both a histogram and a numerical counter (FIG. 5, B). A single click on any of these items can refine the search results as a preview, but may not recalculate the search results/histograms. The selected descriptor can appear in the additional filters search box (FIG. 5, C). Upon double clicking on a facet in the right column or clicking the “pivot” icon (FIG. 5, D), the global query can be performed with the additional filters added (FIG. 5, E). In the illustrated example of FIG. 5, the global query can become: “Water Polo” _indicator=(“Started a Company”). The facets can then be recalculated based on the new global query. A given facet can display one or more descriptors, such as a school descriptor.

The user interface can include one or more navigation bars. Navigation bars can be comprised of a left navigation bar, which can contain the majority of the system features (e.g., streams, activity, events, messaging and settings) and a top bar, which can include access to search, messaging, and the home page.

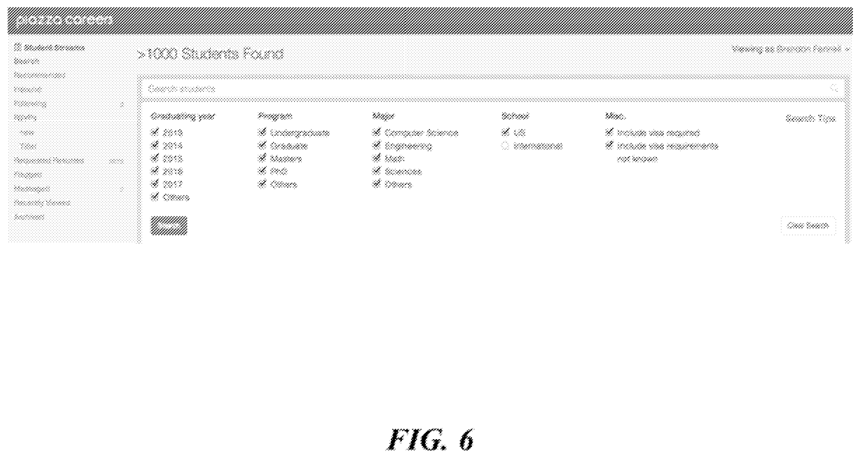

The system can be adapted to present user streams on the user interface, such as student streams. Student streams can enable a user to organize and view students based on specific characteristics and/or requirements of the users, as shown in the examples of FIG. 6. These include, without limitation, the following streams: recommended students, inbound applicants, students who are following the company, students who have expressed a willingness to attend an event (RSVPed), students who have had resumes requested by the company, students who have been messaged by the company, students who have been flagged (e.g., a tag applied by the user), students who have recently been viewed, and students who have been archived.

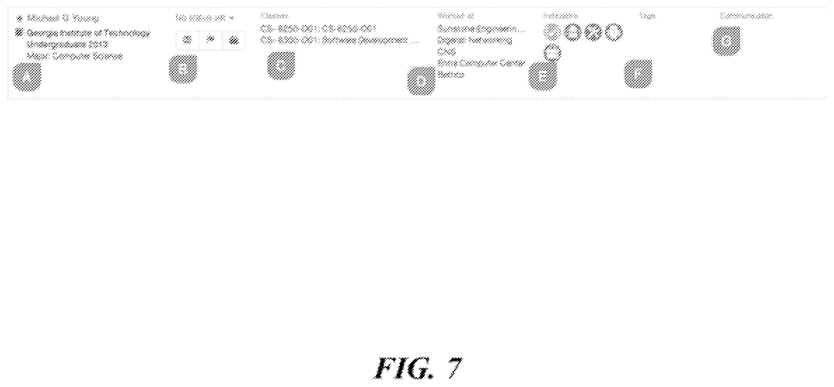

Each user (e.g., student) in a stream can have a visual layout that is the same as the search environment, as shown in FIG. 7. Users can be displayed in a horizontal fashion with a number of characteristics, including, but not limited to, their educational information (FIG. 7, A), status/messaging features (FIG. 7, B), course information (FIG. 7, C), work history (FIG. 7, D), indicator icons or badges (FIG. 7, E) as defined in [0086], tags (FIG. 7, F), and communications (FIG. 7, G) including but not limited to which users (e.g. company employees) contacted or viewed the profile of the user (e.g. student).

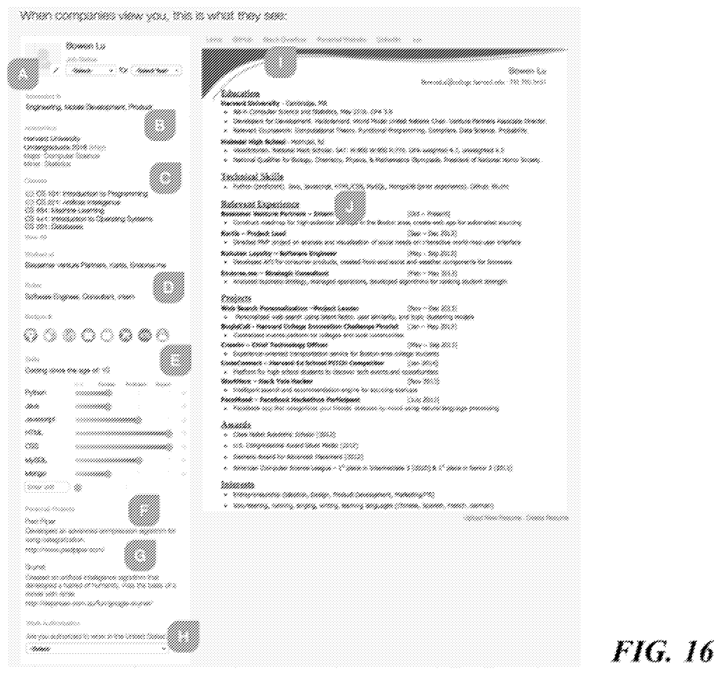

A user can access a student (or other individual or entity) on a stream to view a modal with their full student profile (see, e.g., FIG. 16). This can render the resume in the user interface and allows the user (e.g., recruiter) to message the student, as well as share the student's profile/resume with other users within the company. Navigation (e.g., “Next” and “Previous”) buttons can allow for movement between each of the students in the stream.

From a given stream or search, a user can message students through an internal messaging platform of the system. The user can also flag students for future review and archive students. In some cases, each of these features has its own associated stream(s). The user can also set the status for a student to track them, such as, for example, throughout an interview process. In some examples, the status can be selected from contacted, interview scheduled, interviewing, offer made, hired, rejected, and other.

With reference to FIG. 7, indicator badges (FIG. 7, E) can be determined based on internal tagging efforts by the system or individuals or entities associated with the system, such as administrators of the system. Once an item (e.g., resume) has been tagged, the results can be visually depicted with various badges representing specific indicators (a type of descriptor). The data can be manifested through search as the indicator descriptor, displayed on the facets on the search right sidebar.

The system can enable searching on streams. Results of such a search can be displayed on the user interface. Streams can support the search descriptors described herein. In some cases, the facets may not be visually depicted on the right of the user interface.

### Events

The system can support the ability to host events and receive from a user a willingness to attend an event (e.g., RSVP). Such information can be searchable through an RSVP stream of the system, which can be displayed on the user interface.

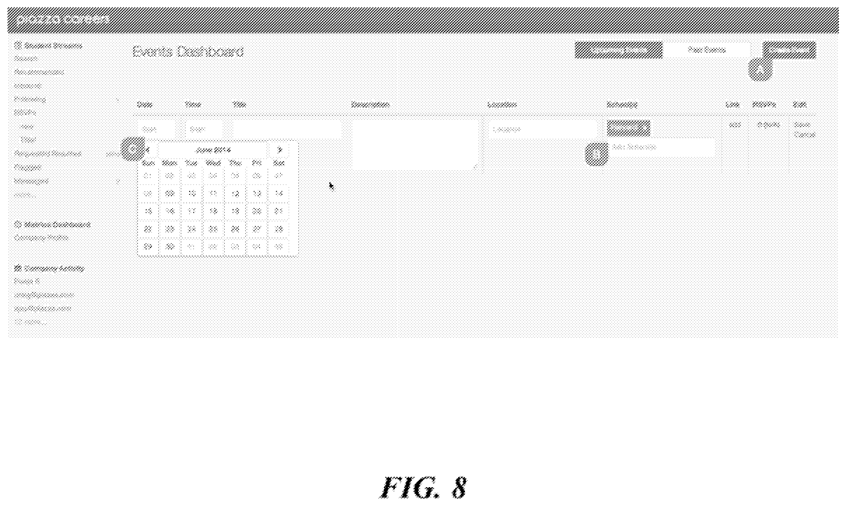

Events can be created by users on an events dashboard of the user interface, as shown in FIG. 8. Users can create events (FIG. 8, A) that are hosted at one or multiple locations (FIG. 8, B), such as schools. Events can be created with customizable dates, titles, descriptions, locations and additional links (FIG. 8, C).

Events can be added in a batch process. Using an Event Clean Up tool of the system, a file (e.g., comma-separated values file) with information about a given event (e.g., date, time, location, school, and title) can be parsed and the information can be reformatted to a uniform style to be used by the system.

### Messaging

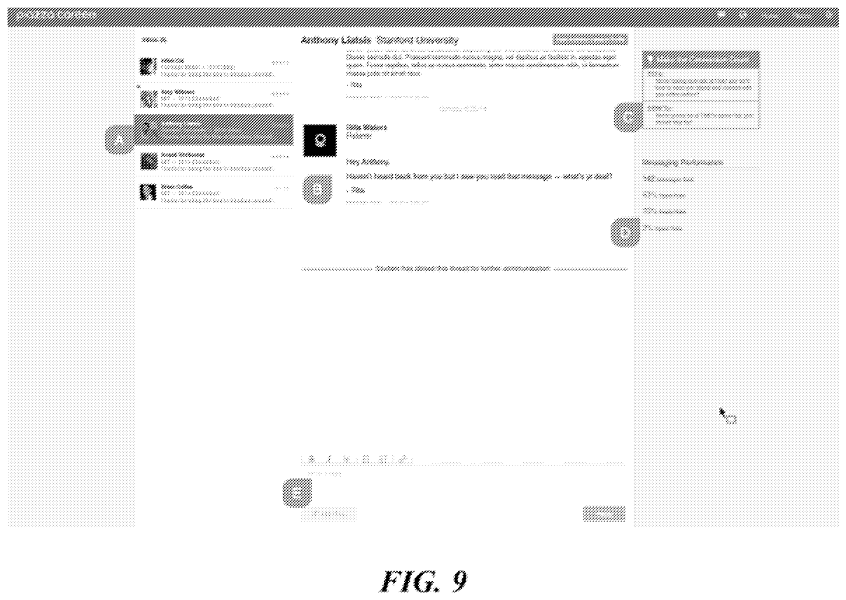

The system can include a messaging interface that allows for communication between students and companies. The messaging interface can be part of the user interface. An example messaging interface is shown in FIG. 9. The messaging interface can display a list of students who have been contacted and sorted chronologically (FIG. 9, A), with a feed style conversation for each student (FIG. 9, B). The interface can also include tips for “best practices” when messaging students (FIG. 9, C), performance metrics that match the home screen dashboard (FIG. 9, D, also see FIG. 2), and an input box with rich text support (FIG. 9, E).

The system can enable users to communicate with one another. In some cases, a user can communicate with another user using a messaging interface, which can be provided on the user interface. Messaging can support nearly identical functionality to a company-side component of the system. In some cases, there may be differences between the company-side and student-side component of the messaging functionality. For instance, students may not be able to initiate messages to companies. Additionally, if a student feels that a given company is sending unsolicited messages (e.g., spam messages) or otherwise does not wish to receive messages from the given company, then the student can request that the system not permit the company to message the user. For example, the student can mark a message as spam or explicitly block the company from sending further messages.

### Analytics

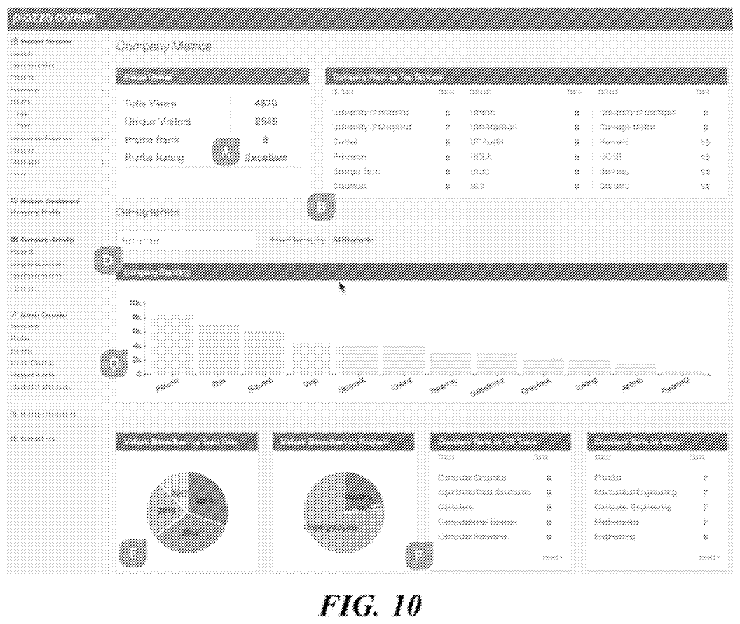

The system can include various analytics tools. In some cases, each company that is part of the system can have a company profile, as described elsewhere herein. A profile analytics dashboard can be created in order to allow users to track overall popularity and traffic to the company profile page (FIG. 10). The dashboard can display information that may be relevant to the company, such as company metrics and demographics. Users may be able to view the company profile's total number of views, unique visitors, and profile rank relative to the other companies on the platform (FIG. 10, A). The profile can also be assigned an internal rating based on the quality and completeness of the content present (e.g., ranging from average to excellent). The rating can be generated in a user subjective manner and/or generated automatically by a scoring system, such as, for example, based on the number of blank fields and the quantity of content (e.g., determined by word count and number of alumni/experience stories) represented on the profile. In some situations, the rating can be generated automatically and subsequently updated by user input. Users can see how they rank at their top schools or against other top companies, sorted by highest to lowest overall rank (FIG. 10, B). A direct comparison of the companies can be shown. A visual representation of a company's overall rank is also shown as a bar graph (FIG. 10, C) and can be customized with filters such as individual schools, graduation years, programs, majors, and courses of focus. This can be accomplished using the provided autocomplete box (FIG. 10, D) or by clicking on any of the school names (FIG. 10, B) or demographic information, such as, but not limited to, the year of graduation, the program of study (e.g., undergraduate, masters, or PhD), major, and course focus based on the types of classes being taken by students (FIG. 10, E-F), for example. The system can provide the ability to view these metrics as a function of time, as well as metrics around diversity (e.g., gender, race and place of origin). Additionally, the system can provide the ability to compare an engagement with other companies on a platform of the system.

The user interface can include an events analytics page which can show, for example, the overall number of RSVPs, rank of the event relative to other events being hosted at the school, and an ability to sort and view events by popularity and time.

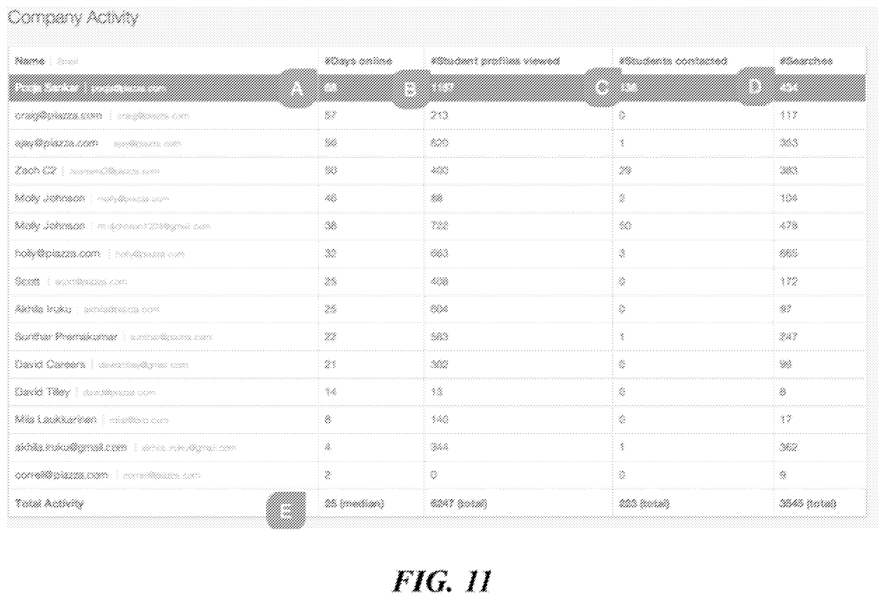

The user interface can also include activity analytics on a user-by-user basis. FIG. 11 shows an example of such analytics. For each user associated with a company, the number of days online (FIG. 11, A), number of student profiles viewed (FIG. 11, B), number of students who were contacted (FIG. 11, C), and number of search results run (FIG. 11, D) can be tracked, as well as the aggregate values for each of these metrics (FIG. 11, E). The user interface can also include an internal dashboard that allows the system to track these metrics and more specific usage of various components of the system.

### Account Management and Collaboration

The system can provide users with the ability to manage their user accounts, including user profiles, and collaborate with other users. Such management and collaboration can be implemented using the user interface of the system. For example, the system can enable users to invite other members of their team through an invite flow. This can allow current users to send customizable messages and activation email links. The sign-up flow may require identifying information of the user, such as user name (e.g., first and last names), a password, and the user's alma mater, to allow for future customization of recommended students.

The system can include a “View As” feature that can allow users to view the activity of other users in the same organization (e.g., company). Changing this view can allow a user to see the specific actions, searches, and student profiles reviewed by another user. This can allow for transparent collaboration between users to help share what they are looking for and what students they are viewing. In some cases, this feature can be activated or deactivated upon user request, or upon request of an administrator of the organization.

### Company Profiles

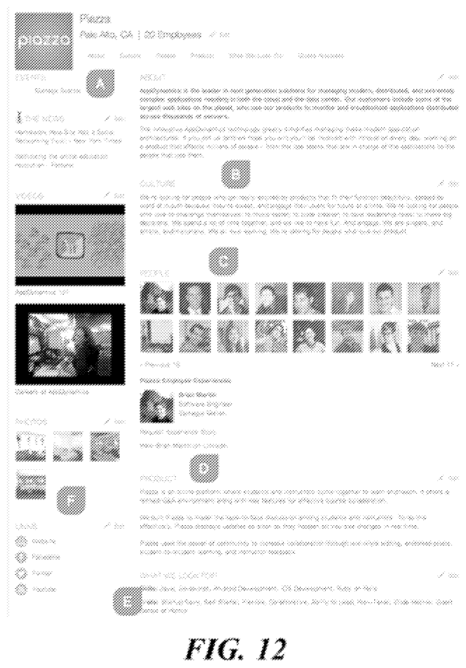

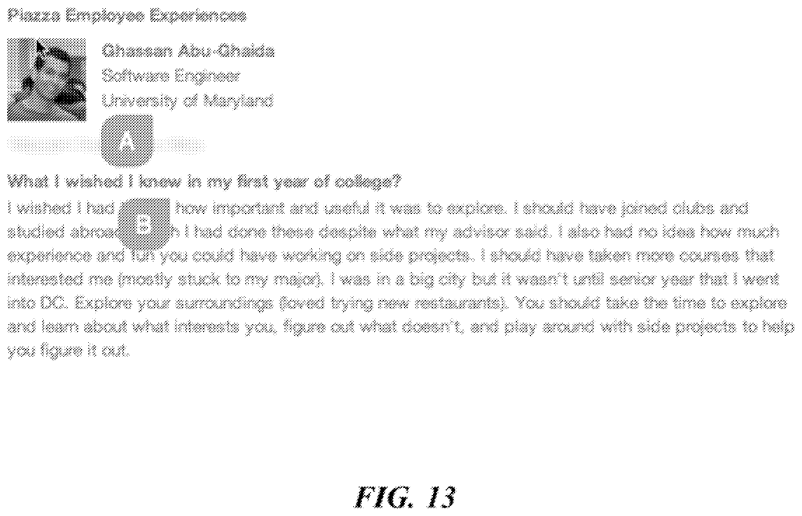

The system can permit an organization (e.g., company) to have a profile. Multiple organizations can have profiles on the system. In some examples, a company profile can allow students to engage and learn more about the company. FIG. 12 shows an example company profile. The profile can include basic company information and upcoming events (FIG. 12, A); an about section (FIG. 12, B), which can describe basic information about the company, including location, size, and the general mission or vision; a culture section (FIG. 12, C), which can describe the work environment, work culture, and any other unique information about the people who work at the company; a people section (FIG. 12, D), which can allow for experience stories and alumni information; a product section (FIG. 12, E), which can describe the main products or services created or supplied by the company; a question and answer section, which allows for the posting of questions and answers to those questions; and a multimedia section (FIG. 12, F), which can include textual information, image information, audio information and/or video information, such as articles, videos, photos and links. The people section can support information about an individual's job title, role, and alma mater (FIG. 13, A). The user can also provide answers to a number of questions (FIG. 13, B). The alma mater information can be used to provide tailored alumni information to students at specific schools, as described elsewhere herein.

The system can permit a user to edit a profile using the user interface. Each section of the profile can be individually editable.

### Notifications

The system can support a number of notifications through the user interface. For example, notifications can be provided through a top bar of the user interface, a side navigation bar of the user interface, and electronic communications, such as electronic mails (emails).

### Career Student Experience

The system can include a careers component that can include various user interface components, including, without limitation, a dashboard in the Q&A component which guides students into the careers component of the system, a company dashboard, individual company profiles, an events dashboard, a settings panel, and messaging, and notifications.

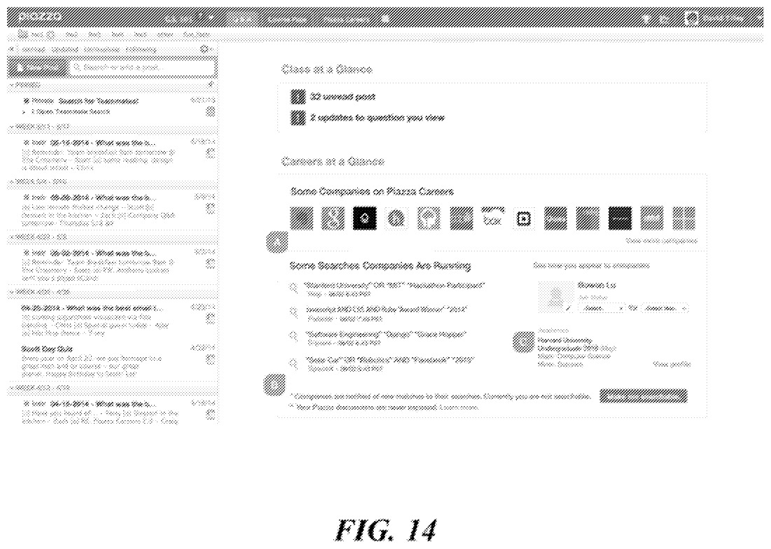

For the Q&A component, the user interface can include a window (or panel) that can provide a gateway to a careers component of the system, as shown in FIG. 14. The window can be static with fixed content, or dynamic with varying content, for example based on companies and events being added to the careers component. The default view can contain information about companies on the careers component (FIG. 14, A), searches being run by select companies (FIG. 14, B), and a snapshot of one or more student profiles (FIG. 14, C).

### Companies Dashboard

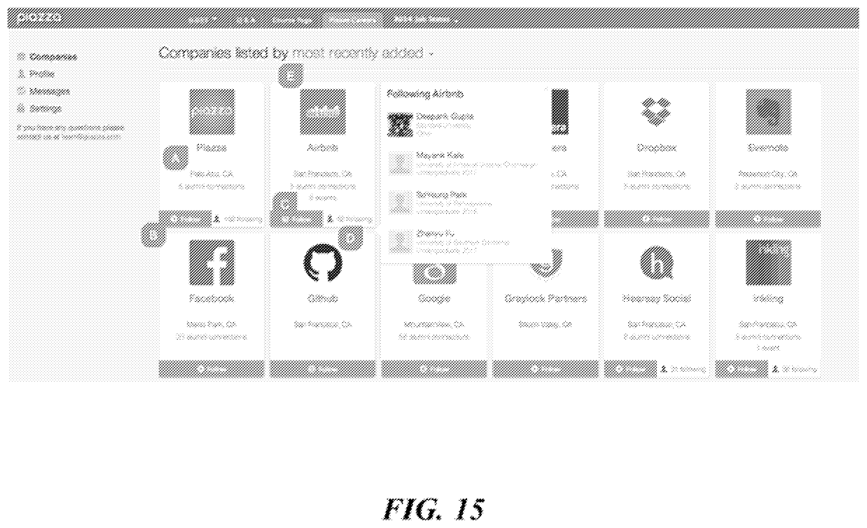

The user interface of the system can include a companies dashboard. The dashboard can facilitate a main mode of discovery of new companies for students. An example companies dashboard is shown in FIG. 15. The dashboard includes a series of company panels or tiles (FIG. 15, A) that depict key information about the company, including, without limitation, the logo, name, and location. The system can enable students to follow companies (FIG. 15, B). This action can determine future recommended companies and also notifies the company being followed of the student's interest by adding them to a “following” stream in the company-side of the system, which can be shown on the user interface. In addition, the user interface can provide information about upcoming events and alumni of the school who work at the company (FIG. 15, C). In some cases, this can be determined by the information imputed into the people section of the company profile. Both the alumni of the company and all of the students following a company can be displayed in a window (FIG. 15, D) upon accessing (e.g., clicking on) a specific piece of the profile. The window can be a popover window. The system can also permit a user to sort companies based on sorting options that can include specific criteria, as shown in FIG. 15, E. These sorting options include, but are not limited to, time of joining the system, company size, similarity to other followed companies, and sorting alphabetically, by geographic location, by the age of the company, by the level of funding, by the series of funding, by the number of alumni, by popularity among users, by activity on the platform, by the number of potential hires, and by the number of hires in the previous year(s). Accessing the company name or logo (e.g., clicking on the name) can load the company profile on the user interface.

When viewing a company profile on the user interface, in addition to following a company, students can choose to apply to the company. In such a case, the system can notify the company (e.g., notify a company-side user) and adds the student to the “inbound” stream of the company. Students may be required to upload resumes or provide other information to apply to the company. In some situations, the system can provide the student with a form on the user interface to complete.

### Events Dashboard

The user interface can include an events dashboard that allows students to explore various events. The events can be past events, present events or future events. The events can be for a location determined by the user or a location that is at or in proximity to a geographic location (geolocation) of the user, which can be determined using an electronic device of the user (e.g., using a global positioning system or wireless triangulation). The style and layout can be the same or similar to that of the companies dashboard. The user interface can display information about the hosting company, name of the event, date, time, location and a description of the event. Students (and other users) may be able to indicate a willingness to attend the event (e.g., RSVP), allowing other users (e.g., recruiters) to be made aware of specific students attending the event. Students can also see the other students who have RSVPed to the event in a style similar or identical to FIG. 15, D.

### Student Profiles

The system can enable students to have profiles. A student profile can be viewed on the user interface. An example student profile is shown in FIG. 16. A student profile can provide at least some, most, the majority or all of the content for company-side content of the system. A student can provide an image (e.g., picture) and set a current job status (e.g., seeking internship, seeking fulltime, seeking co-op, position accepted, employed, or not looking for employment) for a specific time (e.g., 2014-present, 2015-next year) directly on their profile (FIG. 16, A). The student can also provide information about interests of the student with respect to a career choice (FIG. 16, B). The student's educational information and classes that the student has been involved with (e.g., classes taken or for which the student assisted in) can be automatically ported over by the system from the Q&A component of the system (FIG. 16, C). The student can edit a minor, major and graduation year and month of the student. In some cases, the student can provide and update courses that the student has taken, is present taking and may want to take at a future point in time. Previous roles and positions at companies held by the student (FIG. 16, D) can be provided by the student and may also be extracted by the system from various sources, such as a resume of the student (if provided). In some cases, once the student has provided a resume (FIG. 16, J), the resume can be reviewed by the system and tagged with any relevant descriptors (e.g. indicators) (FIG. 16, E). The descriptors may include the descriptors provided elsewhere herein. The student can provide information about various skills (FIG. 16, F) and can assign a skill-rating (e.g., including, without limitation, novice, familiar, proficient and expert) as well as provide information about various projects (FIG. 16, G), which can include personal projects. The system can permit the student to indicate whether the student has restricted work authorization in a given jurisdiction (e.g., the United States) (FIG. 16, H). The system can enable the student to provide links to various third party sites (e.g., Github, Facebook, Twitter, Tumblr, LinkedIn, or a personal website) (FIG. 16, I). Relevant fields on the profile can be enabled for autocomplete, which can improve the homogeneity of data entry.

### Privacy Settings

The system can enable users (e.g., students) to control their exposure to companies through a privacy settings page. Students can be provided with the option to set their job status on this profile, as well as decide which companies can message them. For example, a student can elect to permit all companies on the system to contact the student; only companies being followed by the student and companies similar to those companies to contact the student; only companies being followed by the student to contact the student; or no companies to contact the student.

Upon electing a given option, the student can be automatically prompted by the system with a list of companies to review and elect which of the companies the student wishes to follow. The student can also be permitted to manage the companies that the student has blocked (from messaging the student). In some cases, when a student modifies the companies who can contact them or explicitly blocks a company, the elected companies can see a visual change in the search results on the company side of the system.

In some cases, if a student has not opted in to the careers component of the system, identifying information of the student (e.g., name) will not be shown and a company can request to connect with the student. If the student has not provided a resume, the company can request a resume. If the student has restricted privacy settings of the student, then any company that does not fall within the authorized messaging group can be informed that the student has opted out of messaging on the platform. If a student has blocked a company from contacting the student, then the company may see explicit visual feedback on the student's profile of the user interface informing the company that the student has blocked the company from messaging the company.

In some cases, students can opt out of the careers component of the system on a privacy page of the user interface of the system, as well as under their account settings on the Q&A component of the user interface.

### System Tools

The system provides various tools that enable data collection. The system can provide user interface components to enable users to interact with such tools.

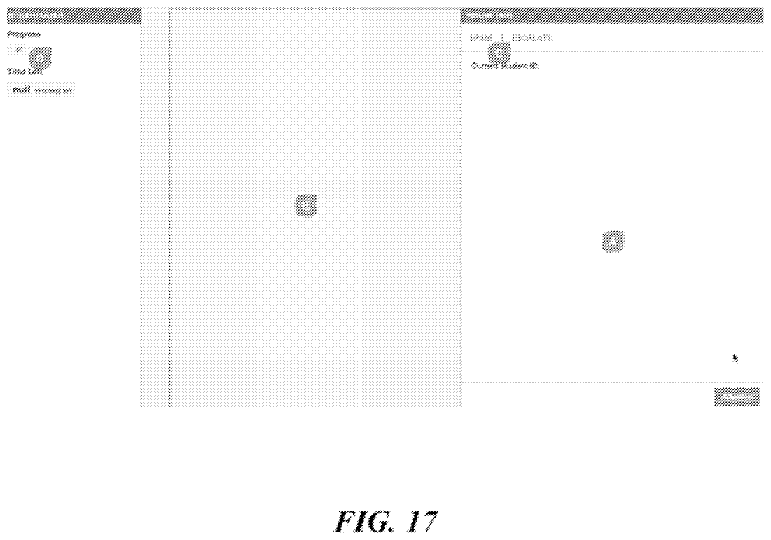

The system can include a resume tool that reviews data being inputted by students and tags the descriptors (e.g. indicators) populated on student profiles (see, e.g., FIG. 16, E) and provided in the search feature. The resume tool can include an interface component that can be part of the user interface of the system. An example interface component is shown in FIG. 17. In the resume tool, sets of tags, which translate into specific descriptors (e.g. indicators), can appear in the right hand column (FIG. 17, A) and the resume renders in the middle of the page (FIG. 17, B). The resume tool can include a number of options to provide the highest quality data possible, such as to either spam (eject from the system) or escalate (allow for manager review) data (FIG. 17, C). Each user may be provided with a predefined queue of resumes and the progress is tracked on the left (FIG. 17, D).

In some cases, a subset of resumes can be selected (e.g., randomly) from users and reviewed by a manager of the system through an administrative dashboard. This dashboard can allow for review of escalated and spammed resumes, to facilitate direct editing of individual students in the case of specific problems.

Each user of the tagging environment can have performance metrics that are tracked in a metrics dashboard, along with the overall rate of progress and the number of new resumes being uploaded to the system.

In some cases, resumes are automatically assigned a tagging priority based on the type of student and school they attend. Tagging priority can be used to establish a preliminary assessment of the quality of a resume by the system. In such a case, the system can identify resumes that have a minimum level of quality (e.g., minimum level of text or layout). Resumes that do not meet such minimum level of quality may be flagged, and users associated with such resumes may be notified and asked to provide higher quality resumes.

The system can include a course (or class) review tool that permits review (e.g., by a manager or administrator of the system) of identifying information of a course in a database of the system to ensure that the correct name and course number is associated with the course in a uniform manner (e.g. CS 225: Machine Learning), which may be in accordance with a university course catalogue, for example. The review tool can include a user interface component that permits a reviewer to review a given class. The course level (lower level undergraduate, upper level undergraduate, or graduate level) courses can also be assigned, as well as a specific course taxonomy, as described elsewhere herein to allow for more robust searching on the company-side of the product.

### Computer Systems for Facilitating Learning and Talent Discovery

Another aspect of the present disclosure provides computer systems that are programmed or otherwise configured for learning and/or talent discovery. The computer system can include an electronic data repository (e.g., a memory location or database) coupled to a computer processor. The electronic data repository can store data that can be relevant to learning and/or talent discovery. Such data can include user data, which may be inputted by a user, aggregated by the computer system, or both.

Data can include identifying information of a student, school or company. Data can also include content that is relevant to the student, school or company, or coursework. Examples of data include, without limitation, identifying information related to a course, homework, project, skills, work experience, employment authorization, interests, student performance and student participation and other information associated with or reported by a user described elsewhere here within.

In some embodiments, the computer system can be programed or otherwise configured to store data in the electronic data repository and search the data for content that can be relevant to learning and/or talent discovery. The computer system can include or be coupled to a user interface to permit a user to search for such content. The user interface can be a graphical user interface (GUI) or a web-based user interface.

The computer system can be used by students and organizations, such as companies. The system can have features and functionalities that are dedicated for use by select users. In some examples, a student-side of the system has features and functionalities that are accessible by students only, and a company-side of the system has features and functionalities that are only accessible by companies.

The system can include a search feature that allows users to find other users (e.g., students) using search criteria that can include one or more keywords, such as a combination of keywords, filters and descriptors. The system can seed initial suggestions. The search can be directed to search criteria inputted by a user. The search can also suggest or enable the user to provide additional refinements.

The system can enable a user to provide various search criteria, which can be used by the system to conduct a search. Such search criteria can include one or more keywords. Keyword searches can search the entire user (e.g., student) profile, including any resumes that may have been uploaded to the system. The search can support Boolean operators and quotes. In some examples, the search feature can be implemented by a search engine (e.g., Sphynx).

Data in the electronic data repository can be collected from various sources, such as material provided by a user (e.g., a resume), network sources (e.g., social networks), electronic communications (e.g., electronic mail), or user input, such as data inputted by a user in a profile of the user.

The electronic data repository can include descriptors, which can map to specific data in the electronic data repository associated with a profile of a user (e.g., student). In the context of schools, this can include student academic credentials, the classes they have taken, where they have worked, their name, their school, their year and month of graduation and other skills and accomplishments from their resumes. This can allow for more specific search dimensions. Certain descriptors can also support taxonomic organization (e.g., for courses, majors and indicators) to allow for more targeted searches unsupported by traditional keyword search queries. Descriptors can support keyword search within their respective datasets.

Systems of the present disclosure can provide users with various options. Such options can be employed in various settings, such as the class descriptor. Additional logic employed with the class descriptor can combine specific criteria to create more focused search results. For example, if a user is searching for students who have taught graduate level web development classes, the following query can return the desired result: classes=(“Web Development”|“TAs”|“grad classes”).

### Searching

Systems of the present disclosure can be programmed or otherwise configured to provide for optimum searching. Systems provided herein can be programmed to return comprehensive results of a search in a time period that is less than about 5000 milliseconds (ms), 1000 ms, 500 ms, 400 ms, 300 ms, 200 ms, 100 ms, or <=10 ms. In some cases, searching comprises the use of enhanced metadata (e.g. descriptors and/or indicators) associated with specific search queries having search criteria. In some situations, a search platform of the system can perform searches on content that includes text strings, or content that only includes text strings.

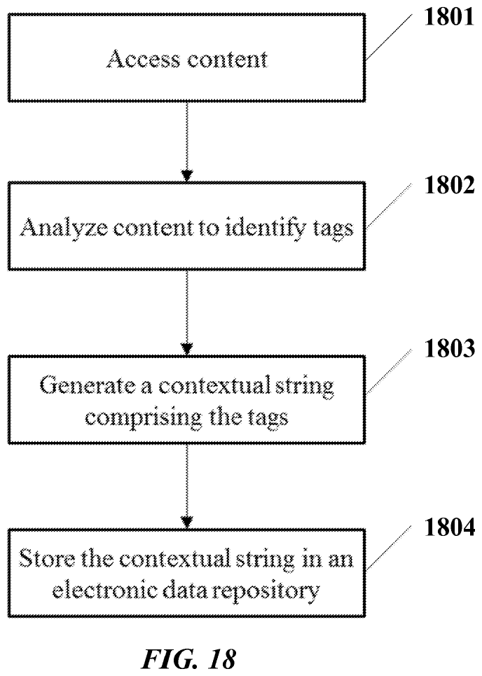

FIG. 18 schematically illustrates a method for storing content. The method can be implemented using a computer system comprising a computer processor that is programmed to store and search content. In a first operation 1801, content is accessed in an electronic data storage unit, such as a memory location or database (e.g., Mongo database (DB)). The content can be directed to learning and/or talent discovery. The content can be provided by a user and/or collected or aggregated from other sources, such as network sources. Examples of network sources include social media sources.

Next, in a second operation 1802, the content is analyzed to identify tags in the content. The tags can then be stored in an electronic data repository coupled to the computer processor.

Next, in a third operation 1803, at least one contextual string from the tags can be generated. The contextual string can provide a contextual relationship among the tags. Such contextual relationship may otherwise not be available upon reviewing the tags alone. Next, in a fourth operation 1804, the contextual string can be stored in an electronic data repository. The contextual string along with other contextual strings can then be indexed (e.g., Sphynx index).

In some situations, the contextual string does not appear in the content but is generated from the tags identified from the content. For example, the tags can be concatenated to generate the contextual string. As an alternative or in addition to, the contextual string can appear in the content. In such a case, the tags can be generated from the contextual string.

A contextual string can be associated with one or more tags. For example, a contextual string can be associated with at least 1, 2, 3, 4, 5, 6, 7, 8, 9, 10, 20, 30, 40, 50, 100, 200, 300, 400, 500, 1000, or >=10,000 tags. A given tag can be associated with one or more contextual strings. For example, a tag can be associated with at least 1, 2, 3, 4, 5, 6, 7, 8, 9, 10, 20, 30, 40, 50, 100, 200, 300, 400, 500, 1000, or >=10,000 contextual strings.

In some examples, from tags stored in an electronic data repository (e.g., database), the tags are accessed by the computer processor and extracted into memory. Next, the tags are transformed to yield a contextual string that comprises the tags. Such transformation can include concatenating the tags together to yield the contextual string. Next, the contextual string is loaded into an electronic data repository (e.g., database). The electronic data repository with the contextual string can be the same electronic data repository for the tags, or a different electronic data repository.

Stored content, tags and contextual strings can be used to search for content. A search can be directed to a query provided by a user. Specific tags can be queried using specific descriptors.

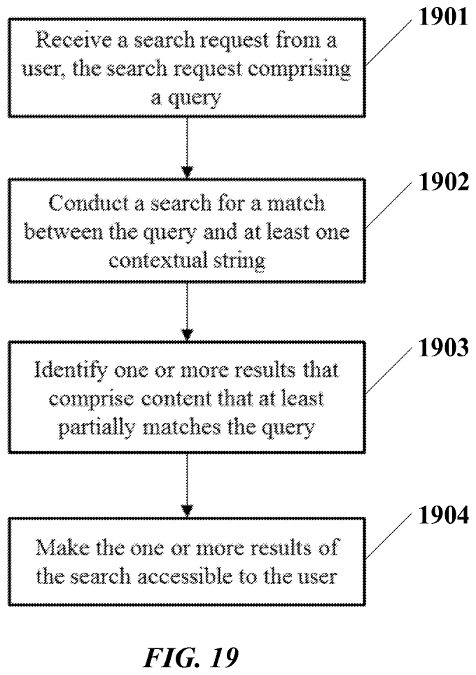

FIG. 19 shows a method for searching content. The content can be directed to learning and/or talent discovery.

In a first operation 1901, a request for a search is received from a user. The request can comprise a query. The query can include one or more tags. Next, in a second operation 1902, a search is conducted for at least a partial, substantial or complete match between the query and at least one contextual string in an electronic data repository. The search can be conducted using a text-based search engine (e.g., Sphynx). Next, in a third operation 1903, one or more results that comprise content that at least partially, substantially or wholly matches the query are identified. In a fourth operation 1904, the one or more results are made accessible to the user. In some examples, the one or more results are presented on a user interface of an electronic device of the user.

In some situations, metadata associated with content can be captured by creating artificial sentences describing the relation of each user to specific content. For example, instead of storing the terms “Machine Learning,” “Advanced Classes” and “Was a TA” as separate items for a student that do not inherently have a contextual relationship that can be queried, the data can be stored in an associative fashion. The content can be stored as “Was a TA for Advanced Machine Learning.” This can allow for more specific queries associated with class information from the system. In some examples, information is stored in a database (e.g., MongoDB) with the relationship(s) between all of the data. This is collected from the information provided about the class on the Q&A component (or platform) or other inputs provided by the student. In order to search using the search engine, it can be translated from a hash map, for example, to one or more strings that can be searched using the search engine. Content can be stored in an associative fashion in an electronic data repository of the system. For example, content can be stored in sentences, which sentences can be associated with one or more tags. This can permit a context associated with tags to be determined.

In some examples, the system employs the use of a search engine (e.g., Sphynx) that can support sentence based queries. In such a case, the metadata associated with each item can be captured by creating artificial sentences describing each student's relation to a specific item. Such artificial sentences can be created from any of the data stored in the data repository.

In some situations, data about a student can be stored using individual tags and such tags are stored in an electronic data repository (e.g., database). The tags can be supplemented with data that can be indicative of the contextual relationship between the tags. This can provide benefits with respect to just storing tags.

In an example, a student took a machine learning class, an advanced class, or was a teaching assistant. Tags associated with such data can be stored in an electronic data repository, but in some cases, such tags by themselves may not provide an indication of the relationship between each of the tags. For example, based on tags, it may be determined that a student took a machine learning class, that it was an advanced level (e.g. upper division undergraduate) course, and that he/she was a teaching assistant (TA) for a given class, but it may be difficult to determine whether the three items are related. Thus, recognized herein is a need to understand the contextual relationship between items associated with tags.

In some embodiments, the computer system can perform a sentence based query using a search engine (e.g., Sphynx) to identify additional contextual information. Such additional contextual information can be stored in an electronic data repository. For example, storing the phrase “was a TA for advanced machine learning” in addition to the tags “machine learning class,” “advanced,” and “TA” can allow the system to more clearly and accurately identify the relationship between tags and data associated with those tags as compared to the use of the tags alone. In this example, it is possible to determine that not only was the student a “TA,” but that this student was a TA for an advanced machine learning course.

### User Profiles

Computers systems of the present disclosure can enable users to have user profiles. Such profiles can include profiles of students and organizations (e.g., companies or schools). The profiles can include content, such as textual content, image content, and/or audio content. Such content can be stored in an electronic data repository of a computer system provided herein.

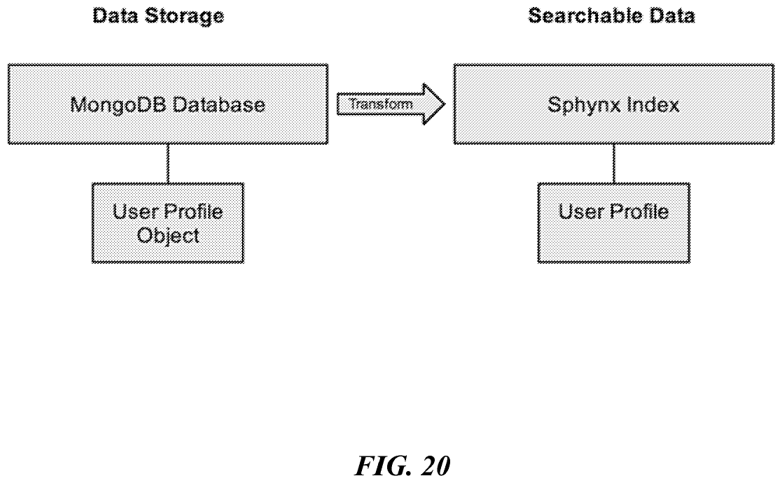

In some examples, user profiles are stored in a database (e.g., mongoDB), as shown in FIG. 20. Each user can have a profile that is dedicated to the user. The profile can be an object in the database. Information about the user (e.g., academic information, skills, courses taken, work experience and resume) can be stored in the user profile object.

Content in a user profile can be transformed into text fields, which can enable the user profile, including the content, to be searchable. In an example, the database stores at least some, most or all of the information as a hash map. This may not be readable by the search engine and may be converted into one or more text strings (e.g., a series of text strings) that can be searched. In order to preserve the context that is stored in the database, some of the data can be transformed into artificial sentences that allow for such context driven query to be run. Such text fields can be associated with a search engine (e.g., Sphynx). The system can provide at least 1, 2, 3, 4, 5, 6, 7, 8, 9, 10, 11, 12, 13, 14, 15, 20, 30, 40, 50, 100, 200, 300, 400, or >=500 text fields. Examples of text fields include without limitation one or more classes that have been taken, are present taken or are planned to be taken by a user; name of the user; identifying information of the school(s) of the user; academic information; user resume; a list of one or more indicator tags associated with the user; work history of the user; data with respect to one or more companies that have viewed the user; streams that the user is included in; and one or more companies that have archived the user. Data, such as class data, can be stored in sentences (e.g., associatively, as described elsewhere herein), which can allow for a context based search.

### Course Mapping

Different schools may have unique names for the same educational training. For example, a course on the C programming language can have different names at different schools. This may make it difficult for a student to compare and relate a course at a first school with a course at a second school. For example, Computer Science 101 at a first school may be the same or similar to Introduction to Computers at a second school.

The system can advantageously include an electronic data repository (e.g., database) that includes a mapping of school attributes across various dimensions, such as minor, major and courses. Such mapping can enable the system to identify a match or similarity of school attributes at various schools. This can enable the system to recommend courses to a student once the system has identified one or more courses that the student has taken, is presently taking or may be taking at a later point in time, in addition to courses that the student may be interested in.

In some cases, the electronic data repository can include a table of course content, such as course name, course description, course difficulty (e.g. lower division, upper division, graduate level, etc.), course term, and a school and major and/or minor that such course may be associated with. The system can review the course content and determine one or more tags associated with such content. A contextual relationship of such tags can also be stored in the electronic data repository, which can enable the system to provide such content upon a search by a student. This can also enable the system to provide the student with an indication of related content, such as similar courses at other schools.

Systems of the present disclosure can include an internal mapping of companies based on a number of dimensions. In some examples, dimensions include objective metrics, such as size, location, and type of company, and magnitude of correlation (e.g., how commonly two companies are followed by the same student), as well as subjective metrics, such as popularity with the student base.

The internal mapping can provide various advantages, such as the ability for a system to provide recommendations to students for similar companies (e.g., based on other companies they are following). The internal mapping can be maintained in an electronic data repository of the system, such as a mapping database. Such mapping can enable the system to recommend companies to the student once the system has identified a subset of companies of interest to the student.

For example, the student indicates interest in a software company, such as by expressing willingness to follow the software company. The system has a mapping of software companies. The mapping has a relationship between the software company and other software companies. For example, the mapping has a table that identifies the software company and the other software companies as belonging to a given type of software company (e.g., a table having Facebook, Twitter and Tumblr as social media companies). The system recommends at least a subset of the other software companies to the student.

### User Interfaces for Providing Engagement Campaigns

A further aspect of the present disclosure provides computer systems with user interfaces that facilitate interaction with prospective talent. A user interface can be a graphical user interface (GUI) or a web-based user interface. The user interface can be displayed on an electronic display of an electronic device of a campaign organizer, such as a mobile (or portable) electronic device. A user interface can include graphical, textual, audio and/or video elements. User interfaces can include icons, panels and interactive fields that enable a campaign organizer to interact with systems provided herein. User interface elements can be arranged in a manner that meets various features and functionalities of systems of the present disclosure. Such arrangement can be generated by a computer processor, such as, for example, upon execution of machine-executable code that conducts a search and generates an output. User interface elements can be static (i.e., not changing) or dynamic (i.e., changing). Dynamic elements can be updated, for example, based on a search. For instance, a user interface can be updated to display search results.

In some embodiments, a user interface for facilitating interaction with prospective talent, such as through the use of engagement campaigns, includes a search field. The search field can be a search box or search panel. The search field can enable a campaign organizer to input search criteria, such as textual and/or graphical information that is directed to search for one or more recipients. The search field can be configured to accept textual information for natural language searching and/or the below described profile information.

The user interface can include one or more output fields that can each display an output of the search. The user interface can include at least 1, 2, 3, 4, 5, 6, 7, 8, 9, 10, 20, 30, 40, 50, 60, 70, 80, 90 or >=100 output fields. In some situations, the user interface can include a comprehensive set of tools to allow a campaign organizer to augment his or her experience.

A computer system (“system”) for developing engagement campaigns can comprise an electronic display that has a user interface that includes a search field. The search can be directed to a query inputted in the search field. The query can be directed to discovering prospective employees to target in a campaign. The one or more descriptors can be descriptors that map to specific data associated with a recipient's profile. The computer system further comprises a computer processor coupled to the electronic display. The computer processor can be programmed to (i) receive the query from the campaign organizer through the search field, (ii) conduct a search of recipients directed to the search query, and (iii) present a result of a search directed to the query.

The system can be used by students and organizations, such as companies. The system can have a student-side career platform that has features and functionalities that are accessible by students only. Additionally, the system can have a company-side campaign platform that has features and functionalities that are only accessible by companies/campaign organizers.

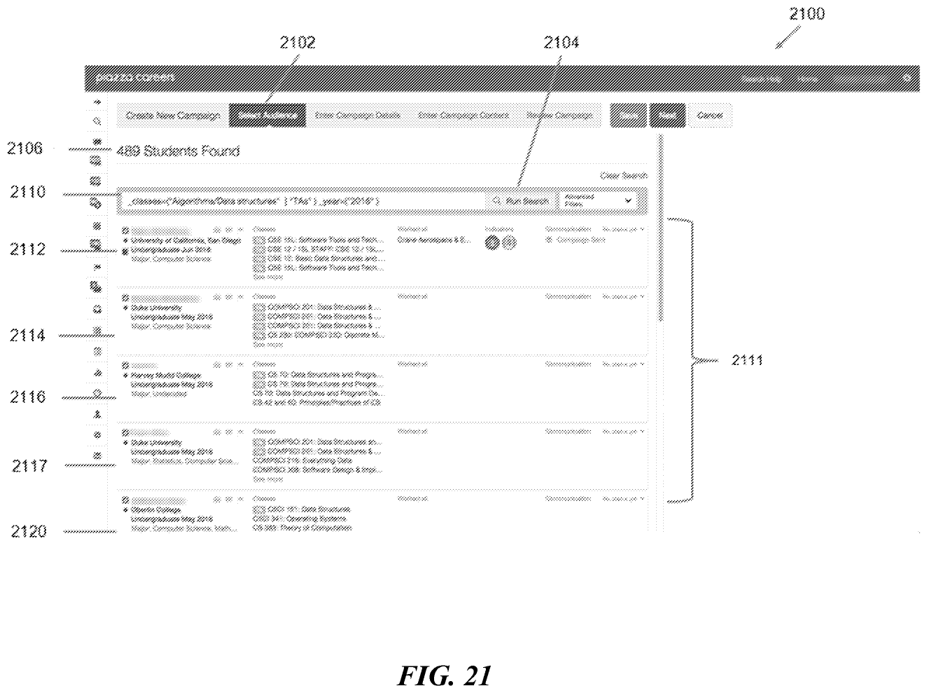

To initially set up a campaign, an audience is defined. An audience may include recipients of the campaign. The audience may be pre-selected or the audience may be discovered using a search process described elsewhere here within. FIG. 21 shows a user interface 2100 illustrating search options associated with a process of selecting an audience for a campaign. As such, user interface 2100 shows an expanded “Select Audience” tab 2102 that comprises a search field 2110. Search field 2110 is able to receive input relating to characteristics that are desired in a campaign audience. Any combination of keywords and proprietary descriptors may be used to search for the audience. Examples of descriptors may include, but are not limited to: specifying year of graduation, type of program (e.g. PhD, M.S. or Bachelors), institution of attendance, major, minor, coursework taken, previous work experience, specific skills, projects, interests, desired careers, and any other information contained on a resume and/or an individual student profile. These descriptors can be used to determine relevance of potential recipients.

Once search field 2110 has been filled with the desired characteristics, a “Run Search” component 2104 may be engaged, a campaign organizer can perform a first type of selection (e.g., click) on the user interface to apply a given descriptor to the search, in which case the search can be conducted with the descriptor added as a filter. After search has been run, results 2112, 2114, 2116, 2118, and 2120 may be listed below search field 2110. Results 2112-2120 can include, but are not limited to, information that may be relevant to a query inputted in the search field 2110.

The area below search field 2110 may be referred to as a “stream” 2111 where a campaign organizer may scan through search results 2112-2120 or scan further through stream 2111 to additional search results (not shown). Additionally, interface 2100 may provide a results indicator 2106 that lists the resulting number of matches to a search query. As shown in FIG. 21, results indicator 2106 shows that 489 students have been found to match a search query. While FIG. 21 describes results indicator 2106 as comprising 489 students, a search query may also include other, non-student categories of potential talent (e.g. alumni) that may be of interest to a company conducting an engagement campaign.

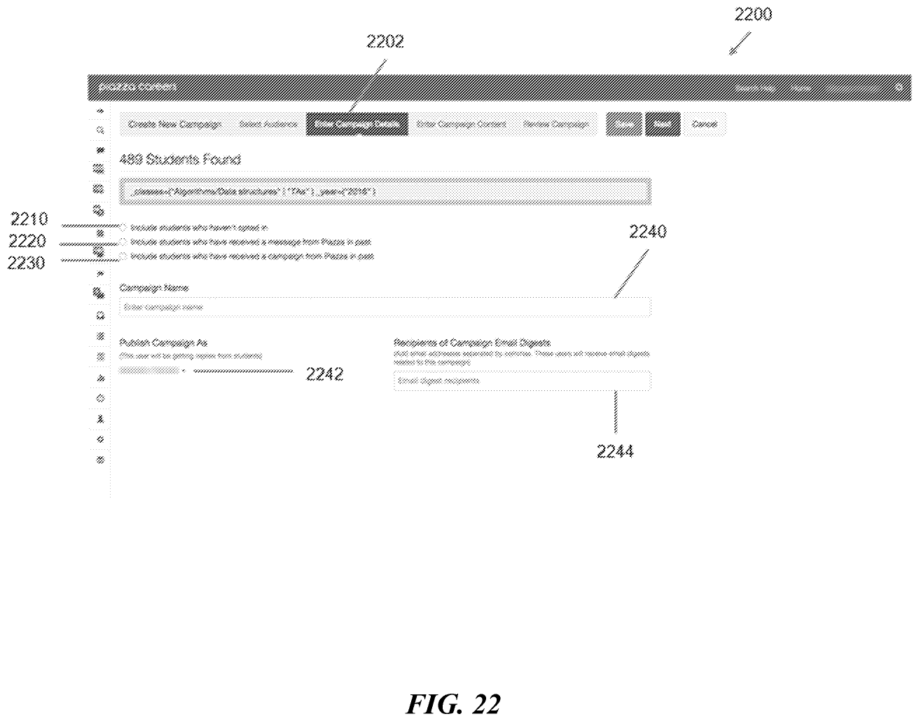

Once an audience of potential talent has been identified, a subset of the potential talent may be selected to be recipients using messaging preferences. FIG. 22 shows a user interface 2200 illustrating messaging options. As such, user interface 2200 shows an expanded “Enter Campaign Details” tab 2202 that comprises message preferences and logistical information.

In an example of message preferences, there may be two categories of recipients considered for an engagement campaign: “Opted-In” recipients; and “Opted-Out” recipients. “Opted-In” recipients are recipients who have allowed their name and/or profile to be made available through the platform. In some examples, “Opted-In” recipients may allow the platform to show their name/profile along with their program information and coursework. Further, “Opted-Out” recipients are recipients who have removed access to at least some data and who will not appear in a search result associated with the career website and campaign audience selection.

In an example of identifying a subset of potential talent to be campaign recipients based on messaging preferences, “Opted-in” recipients may be messaged as an audience for a campaign.

In an example of a default, students (talent) who have already received a campaign or regular message from a company may not receive an additional campaign. Some companies may choose to only target unique recipients who have not been previously contacted. In another embodiment, however, a campaign organizer may override this rule and may choose to include recipients who have previously received a campaign and/or regular company message (e.g. sent outside the campaign management system), and may send a campaign to these recipients, too. In particular, a campaign organizer may choose a subset of potential talent that includes “Opted-In” recipients as well as recipients who have received a message and/or a campaign from a company in the past. As such, the campaign organizer may select button 2220 or 2230, respectively, as illustrated in FIG. 22.

In particular, button 2220 allows a campaign organizer to “Include students who have received a message from Piazza in the past.” Accordingly, when button 2220 is engaged, the audience of the campaign may include recipients that are students who have opted in as well as recipients that are students who have received a message from the company in the past. Similarly, button 2230 allows a campaign organizer to “Include students who have received a campaign from Piazza in the past.” Accordingly, when button 2230 is engaged, the audience of the campaign may include recipients that are students who have opted in as well as recipients that are students who have received a campaign from the company in the past.

FIG. 22 also illustrates areas to manage general logistics of generating an engagement campaign. In particular, FIG. 22 shows a campaign name input 2240; a publishing campaign identifier 2242; and a recipient(s) of campaign email digests input 2244. Campaign name input 2240 may be used to input a campaign name. The campaign name is used for internal coordination purposes only. Additionally, a publishing campaign identifier 2242 may indicate an identified sender of the campaign. The sender of the campaign may be the person/entity/identifier that is associated with sending the campaign to the campaign audience. For example, the sender may be identified as a platform member; as someone who is affiliated with a company that is generating the campaign (e.g., a company engineer, a recruiter, an executive, a celebrity endorser, etc.); or a system generated message (e.g., “<company> College Recruiting”).

Further, a recipient(s) of campaign email digests input 2244 may be a person who receives periodic email notifications that contain information associated with the campaign. For example, the digest recipient may receive information related to how many recipients interacted with the campaign (e.g., how many recipients read the campaign, how many responded, etc.). The digest recipient may be specified in input 2244.

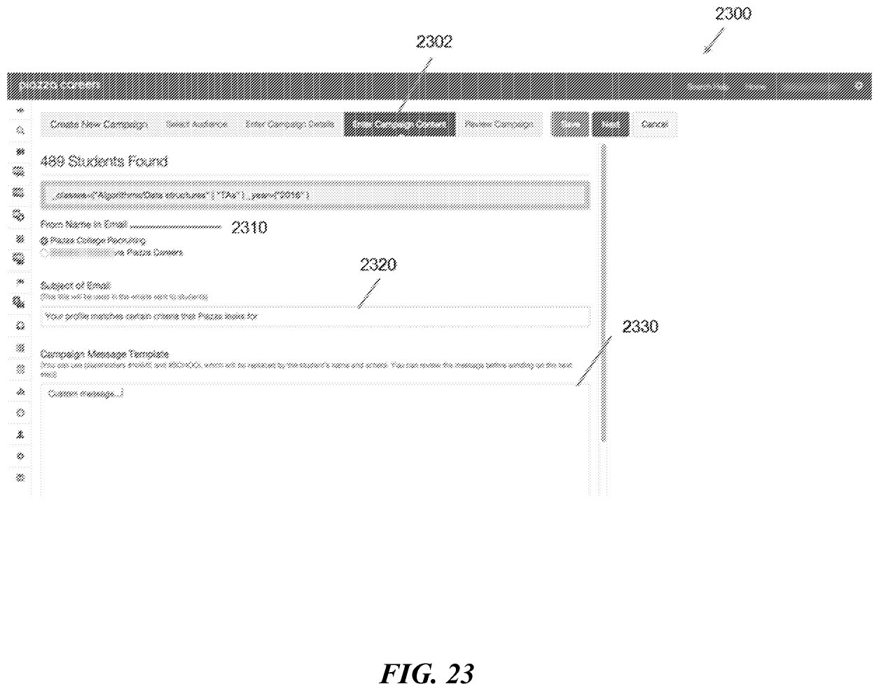

Once messaging settings and logistical information have been input, the content of the campaign may be input. FIG. 23 shows an interface 2300 illustrating input options associated with a process of generating campaign content. As such, user interface 2300 shows an expanded “Enter Campaign Content” tab 2302 that comprises a name input 2310; a subject input 2320; and a campaign message input 2330.

In an example of an engagement campaign, a campaign audience of recipients may receive two notifications associated with the campaign. Initially, the campaign audience may be sent an in-product notification, such as a notification that is received through a career website. The in-product notification may be identical to messaging notifications associated with the career website. Additionally, the campaign audience may be sent a personal notification, such as a notification sent to a recipient's personal email address and/or to the recipient's account-specified email address.

When notifications are sent to a recipient, the name that appears in a “From” section of the notification may be set at name input 2310. For example, the name that appears in the “From” section of the notification may be “<company name> College Recruiting” or “<person's name> via Piazza Careers.” The subject of the notification may also be modified. In particular, the subject of the notification may be modified at subject input 2320.

A campaign organizer may also enter campaign message content into campaign message input 2330. In particular, campaign message input 2330 may be tailored so as to include fields that are modifiable based on personalized information associated with recipients in a campaign audience. For example, a campaign organizer may insert a field for #NAME that automatically updates to the first name of the specific recipient of the campaign audience. In another example, the campaign organizer may insert a field for #SCHOOL that automatically updates to the current school/university/institution that is associated with an individual's profile on the career website. The message can also be formatted using standard HTML tags (e.g. <a> tags for links, <b> for bold, etc.).

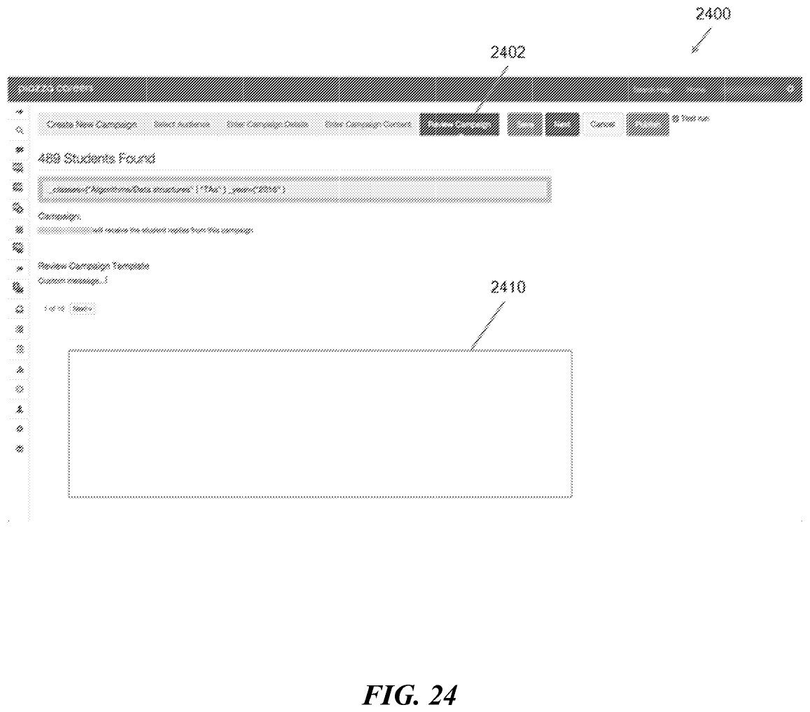

After the campaign message content has been entered, the campaign message may be previewed. FIG. 24 shows a user interface 2400 illustrating preview options for reviewing an engagement campaign notification. As such, user interface 2400 shows an expanded “Review Campaign” tab 2402 that comprises a review campaign template 2410. Information that is associated with the campaign may be displayed within review campaign template 2410. Accordingly, the engagement campaign may be previewed before launching the campaign. User interface 2400 may include information that informs the campaign organizer who will be receiving replies to the campaign. Additionally, review campaign template 2410 may be used to preview a campaign notification to verify that placeholders, such as #NAME and #SCHOOL, are working properly. Further, once campaign content has been verified, a “test run” may be performed. A “test run” may allow an administrator to see how many recipients will receive the campaign. After reviewing the campaign notification, and optionally performing a “test run,” the campaign may be delivered to the campaign audience.

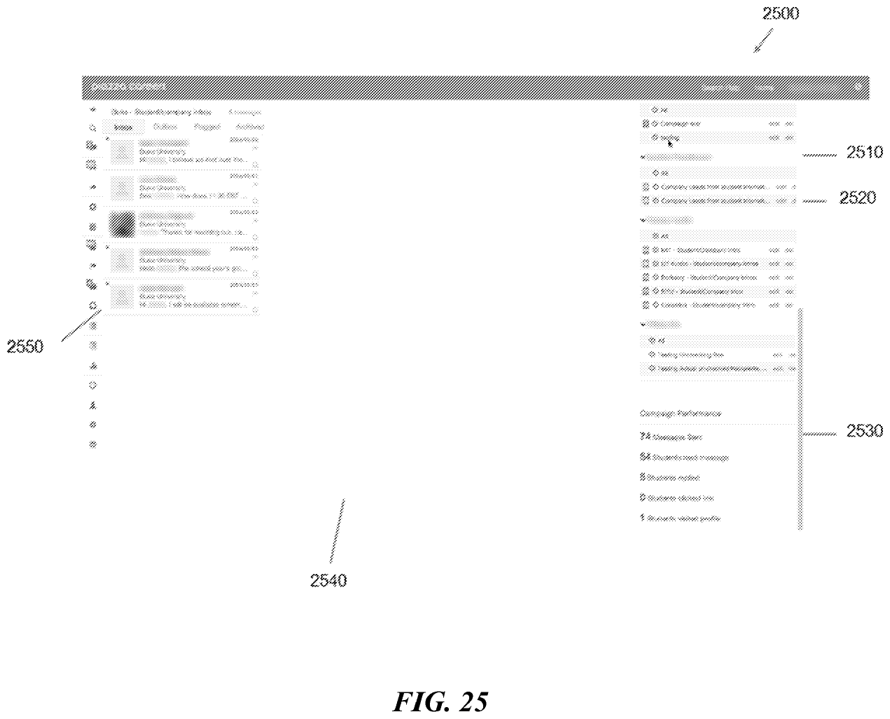

After an engagement campaign has been launched, results of the campaign may be reviewed at a campaign administration page. Accordingly, FIG. 25 shows a user interface 2500 illustrating a campaign administration page.

At the right portion of the campaign administration page, campaign organizers 2510 who have previously launched campaigns are listed. Additionally, campaigns 2520 that have been sent are also listed at the right portion of the campaign administration page. In particular, each campaign organizer that has launched campaigns can be seen on the right of the campaign administration page with the associated campaigns listed below each name. Further, if the campaign listed has been launched, there will be a checkmark next to the name.

Additionally, at the left portion of the central administration page, an inbox 2550 is provided. The inbox 2550 is accessed by selecting a campaign from the list of campaign on right panel 2520. Panel 2520 also provides an indicator of which messages have not been read. In particular, any unread responses are depicted with a colored number next to the name corresponding to the number of unread responses. The inbox 2550 illustrates messages to a campaign organizer from each recipient who responds to the campaign. Accordingly, inbox 2550 illustrates a first panel listing at least a subset of recipients among a plurality of recipients who have each responded to a targeted message among targeted messages as part of a talent campaign. Clicking on the specific recipient allows the message to be read and responded to identically to the rest of the message functionality in the product. The message can be displayed in the area 2540. As such, area 2540 may be used to provide a second panel showing a reply message from a select one of said one or more recipients in response to said targeted messages being directed to said plurality of recipients. Additionally, the system provides an outbox (not shown). When using an outbox, an administrator is able to see a list of campaign recipients, even if the recipients did not read or respond to the campaign.

For each campaign, various metrics 2530 may be tracked. Such metrics include, without limitation, the number of messages sent as part of a campaign, the number of recipients who have read the messages, the number of recipients who have replied to the messages, the number of recipients who have clicked a link included in the messages, and the number of recipients who have visited a profile. For example, the number of messages sent to individual recipients may be tracked. Additionally, the number of messages that are read by recipients, as well as the number of responses received from recipients, may be tracked. The number of recipients who clicked a link within a campaign message may also be tracked. Further, the number of recipients who visited the profile of the company launching the campaign may be tracked. In this way, the results of a campaign can be reviewed in a thorough and meaningful way. In this way, the present disclosure may provide a third panel with metrics 2530 of said talent campaign, which metrics include one or more of (i) a number of targeted messages sent to recipients as part of said talent campaign, (ii) a number of recipients who have read said targeted messages, (iii) a number of recipients who replied to said targeted messages, (iv) a number of recipients who have taken an action within the message, and (v) a number of recipients who have viewed a profile associated said talent campaign.

In order to provide the components discussed in FIG. 25, a computer processor coupled to an electronic display may be programmed to (i) receive responses from said at least said subset of recipients among said plurality of students in response to said targeted messages being directed to said plurality of recipients as part of said talent campaign, (ii) update a first panel, such as inbox 2550, to reflect said subset of recipients, (iii) display said reply message in a second panel, such as area 2540, upon user input in said first panel, and (iv) update metrics, such as metrics 2530, in a third panel.

The manner in which campaigns are presented can enable a campaign organizer (e.g., administrator) to track messages sent to recipients and whether such recipients have viewed the messages and responded to the messages. This can enable the administrator to tailor an effective follow-up strategy. For example, the administrator may follow up with recipients who have not read the messages or who have read the messages but not yet replied. Such follow-up may be selected to be in a manner that is minimally disruptive, such as at a frequency that minimizes email clutter or is not directed to recipients who have replied to the messages.

### Computer Systems

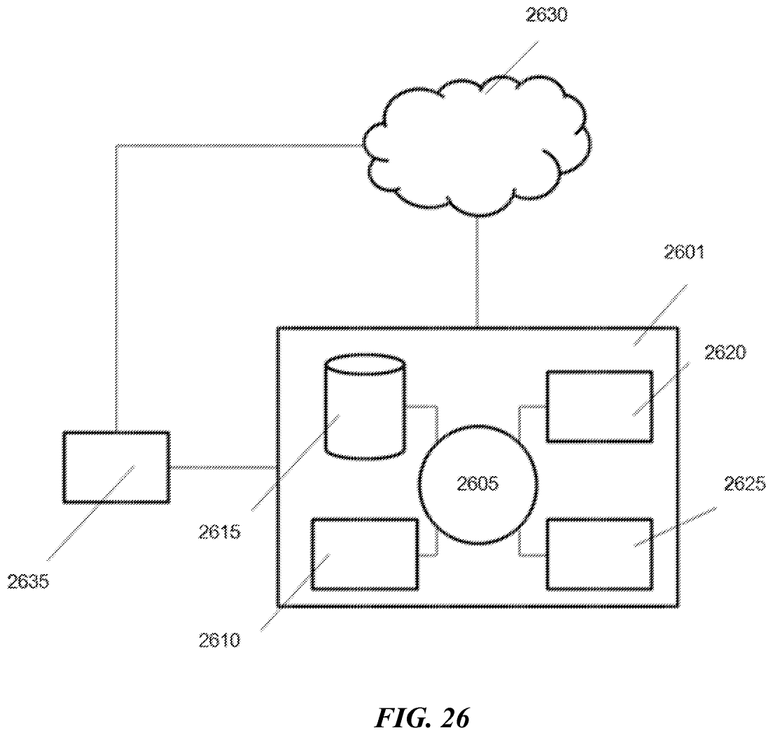

The present disclosure provides computer control systems that are programmed to implement methods of the disclosure. FIG. 26 shows a computer system 2601 that is programmed or otherwise configured to implement talent and/or learning systems, methods, and user interfaces of the present disclosure. The computer system 2601 includes a central processing unit (CPU, also “processor” and “computer processor” herein) 2605, which can be a single core or multi core processor, or a plurality of processors for parallel processing. In examples of the present disclosure, the computer processor may be programmed to (i) receive responses from recipients in response to targeted messages being directed to the recipients as part of a talent campaign. The processor may also be used to update user interfaces, display reply messages, and update metrics associated with the talent campaign. The computer system 2601 also includes memory or memory location 2610 (e.g., random-access memory, read-only memory, flash memory), electronic storage unit 2615 (e.g., hard disk), communication interface 2620 (e.g., network adapter) for communicating with one or more other systems, and peripheral devices 2625, such as cache, other memory, data storage and/or electronic display adapters. The memory 2610, storage unit 2615, interface 2620 and peripheral devices 2625 are in communication with the CPU 2605 through a communication bus (solid lines), such as a motherboard. The storage unit 2615 can be a data storage unit (or data repository) for storing data. The computer system 2601 can be operatively coupled to a computer network (“network”) 2630 with the aid of the communication interface 2620. The network 2630 can be the Internet, an internet and/or extranet, or an intranet and/or extranet that is in communication with the Internet. The network 2630 in some cases is a telecommunication and/or data network. The network 2630 can include one or more computer servers, which can enable distributed computing, such as cloud computing. The network 2630, in some cases with the aid of the computer system 2601, can implement a peer-to-peer network, which may enable devices coupled to the computer system 2601 to behave as a client or a server.

The CPU 2605 can execute a sequence of machine-readable instructions, which can be embodied in a program or software. The instructions may be stored in a memory location, such as the memory 2610. Examples of operations performed by the CPU 2605 can include fetch, decode, execute, and writeback.

The CPU 2605 can be part of a circuit, such as an integrated circuit. One or more other components of the system 2601 can be included in the circuit. In some cases, the circuit is an application specific integrated circuit (ASIC).

The storage unit 2615 can store files, such as drivers, libraries, and saved programs. The storage unit 2615 can store user data, e.g., user preferences and user programs. The computer system 2601 in some cases can include one or more additional data storage units that are external to the computer system 2601, such as located on a remote server that is in communication with the computer system 2601 through an intranet or the Internet.

The computer system 2601 can communicate with one or more remote computer systems through the network 2630. For instance, the computer system 2601 can communicate with a remote computer system of a user (e.g., student, school, or company). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2601 via the network 2630.

Methods as described herein can be implemented by way of machine (e.g., computer processor) executable code stored on an electronic storage location of the computer system 2601, such as, for example, on the memory 2610 or electronic storage unit 2615. The machine executable or machine readable code can be provided in the form of software. During use, the code can be executed by the processor 2605. In some cases, the code can be retrieved from the storage unit 2615 and stored on the memory 2610 for ready access by the processor 2605. In some situations, the electronic storage unit 2615 can be precluded, and machine-executable instructions are stored on memory 2610.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2601 can include or be in communication with an electronic display 2635. The electronic display 2635 can be part of the computer system 2601, or coupled to the computer system 2601 directly or through the network 2630. The electronic display can include a user interface (UI) for providing various features and functionalities described herein. In an example of the present disclosure where a computer system for talent campaign management is provided, an electronic display may comprise a user interface that includes a first panel listing at least a subset of recipients among a plurality of recipients who have each responded to a targeted message among targeted messages as part of a talent campaign. The user interface may also include a second panel showing a reply message from a select one of said one or more recipients in response to said targeted messages being directed to said plurality of recipients. Additionally, the user interface may include a third panel with metrics of said talent campaign, where the metrics include one or more of (i) a number of targeted messages sent to recipients as part of a talent campaign, (ii) a number of recipients who have read said messages, (iii) a number of recipients who replied to said targeted messages, (iv) a number of recipients who have taken an action within the message, and (v) a number of recipients who have viewed a profile associated with said talent campaign. Examples of UI's include, without limitation, a graphical user interface (GUI) and web-based user interface.

Methods and systems of the present disclosure can be implemented by way of one or more algorithms. An algorithm can be implemented by way of software upon execution by one or more computer processors.

Although systems and user interfaces of the present disclosure have been described in the context of learning and talent discovery and providing engagement campaigns, systems and user interfaces disclosed herein can be employed for use in other contexts, such as content searching. In some examples, systems and user interfaces of the present disclosure can be employed for use in searching textual content, image content, audio content, and/or video content. For example, systems and user interfaces provided herein can be employed to search for music and video.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for searching for multi-dimensional career content over a network, comprising:
(a) collecting content related to educational attributes about a plurality of job candidates from one or more resources over the network;
(b) processing the content to identify a plurality of tags in the content and generating a contextual relationship among the plurality of tags;
(c) organizing the content in a memory location based on the plurality of tags and the contextual relationship that permits searching of the content along multiple dimensions; and
(d) providing, on a graphical user interface, a first panel comprising a plurality of filtering options corresponding to the multiple dimensions and a second panel displaying indicators for at least a subset of the plurality of job candidates, wherein the indicators are generated based on the contextual relationship and the plurality of tags.

2. The computer-implemented method of claim 1, wherein the contextual relationship is stored in a database as a contextual string.

3. The computer-implemented method of claim 2, wherein the database is configured to store the content in a hash map.

4. The computer-implemented method of claim 1, wherein the indicators include information inferred from the contextual relationship and the plurality of tags associated with the subset of the plurality of job candidates.

5. A computer system for searching for multi-dimensional career content over a network, comprising:
an electronic data repository configured to store content related to a plurality of educational attributes associated with a plurality of job candidates, wherein the content is stored in a data structure including a plurality of tags and a contextual relationship;
a computer processor coupled to the electronic data repository, wherein the computer processor is configured to:
(a) process the content to identify the plurality of tags;
(b) generate a contextual relationship among the plurality of tags, wherein the plurality of tags and the contextual relationship permits searching of the content along multiple dimensions;
(c) provide, on a graphical user interface, a first panel comprising a plurality of filtering options corresponding to the multiple dimensions, and a second panel displaying indicators for at least a subset of the plurality of job candidates, wherein the indicators are generated based on the contextual relationship and the plurality of tags.

6. The computer system of claim 5, wherein the contextual relationship is stored in the electronic data repository as a contextual string.

7. The computer system of claim 5, wherein the indicators include information inferred from the contextual relationship and the plurality of tags associated with the subset of the plurality of job candidates.

8. One or more non-transitory computer storage media storing instructions that are operable, when executed by one or more computers, to cause the one or more computers to perform operations comprising:
(a) collecting content related to educational attributes about a plurality of job candidates from one or more resources over a network;
(b) processing the content to identify a plurality of tags in the content and generating a contextual relationship among the plurality of tags;
(c) organizing the content in a memory location based on the plurality of tags and the contextual relationship that permits searching of the content along multiple dimensions; and
(d) providing, on a graphical user interface, a first panel comprising a plurality of filtering options corresponding to the multiple dimensions and a second panel displaying indicators for at least a subset of the plurality of job candidates, wherein the indicators are generated based on the contextual relationship and the plurality of tags.

9. The one or more non-transitory computer storage media of claim 8, wherein the contextual relationship is stored in a database as a contextual string.

10. The one or more non-transitory computer storage media of claim 9, wherein the database is configured to store the content in a hash map.

11. The one or more non-transitory computer storage media of claim 8, wherein the indicators include information inferred from the contextual relationship and the plurality of tags associated with the subset of the plurality of job candidates.
